(19) United States
(12) Patent Application Publication
(10) Pub. No.: US 2026/0236777 A1
(43) Pub. Date: Aug. 13, 2026

(54) Frequency-Focused Latent Representations of Electrocardiograms

(71) Applicant: Google LLC, Mountain View, CA (US)

(72) Inventors: Farhad Iraj Hormozdiari, Watertown, MA (US); Abhishek Sharma, Boston, MA (US); Justin Thomas Cosentino, Philadelphia, PA (US); Cory Yuen Fu McLean, Newton, MA (US)

(21) Appl. No.: 19/538,774

(22) Filed: Feb. 12, 2026

Related U.S. Application Data
(60) Provisional application No. 63/757,672, filed on Feb. 12, 2025.

(51) Int. Cl. G06N 3/084; G06N 3/02; G06N 3/045; G06N 3/08

(52) U.S. Cl. CPC G06N 3/084; G06N 3/02; G06N 3/045; G06N 3/08

(57) ABSTRACT

Provided are computing systems and methods that can enhance the analysis and interpretation of electrocardiograms (ECGs) by employing a machine-learned model to generate latent representations of ECGs that encode frequency-based information contained in the ECG.

### RELATED APPLICATIONS

This application claims priority to and the benefit of U.S. Provisional Patent Application No. 63/757,672, filed Feb. 12, 2025, and titled “Frequency-Focused Latent Representations of Electrocardiograms”. U.S. Provisional Patent Application No. 63/757,672 is hereby incorporated by reference in its entirety.

### FIELD

The present disclosure relates generally to machine learning processes and machine-learned devices and systems. More particularly, the present disclosure relates to frequency-focused latent representations of electrocardiograms.

### BACKGROUND

Electrocardiograms (ECGs) are an advantageous tool in non-invasive cardiac diagnostics, providing beneficial insights into a patient's heart health from the initial clinical interaction. The capacity to accurately interpret ECG signals is important for delivering effective patient care. However, traditional methods of ECG analysis can include variability and inaccuracies, which can lead to diagnostic errors and less than optimal patient outcomes. These challenges are further exacerbated by the high-dimensional nature of ECG data, which necessitates sophisticated analysis techniques to extract clinically relevant information.

Recent developments in artificial intelligence (AI), particularly through the implementation of foundation models that employ self-supervised learning (SSL), have demonstrated potential in improving the analysis of extensive ECG datasets without extensive manual annotation. These models can compress high-dimensional ECG data into lower-dimensional representations that can be beneficial for various clinical tasks, including the detection of arrhythmias, heart failure, and assessing patient risk levels. Despite these advancements, current SSL approaches exhibit notable limitations regarding transparency and interpretability—qualities that are beneficial for clinical reliance in healthcare applications.

### SUMMARY

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

One general aspect includes a computing system configured to generate predictions from electrocardiograms. The computing system includes one or more processors; and one or more non-transitory computer-readable media that collectively store: a machine-learned encoder model configured to process an input electrocardiogram to generate, as an output of the machine-learned encoder model, at least a portion of a latent representation of the input electrocardiogram, where the latent representation of the input electrocardiogram may include a plurality of representation dimensions, where a plurality of different subsets of the plurality of representation dimensions encode information from the input electrocardiogram associated with a plurality of different sub-bands of frequencies. The computer-readable media that also collectively store a machine-learned prediction model configured to process at least the portion of the latent representation to generate, as an output of the machine-learned prediction model, a prediction. The computer-readable media also collectively store instructions that, when executed by the one or more processors, cause the computing system to perform operations, the operations may include: obtaining the input electrocardiogram; processing the input electrocardiogram with the machine-learned encoder model to generate at least the portion of the latent representation of the input electrocardiogram; processing at least the portion of the latent representation with the machine-learned prediction model to generate the prediction; and providing the prediction as an output. Other embodiments of this aspect include corresponding computer systems, apparatus, and computer programs recorded on one or more computer storage devices, each configured to perform the actions of the methods.

Implementations may include one or more of the following features. The computing system where the latent representation may include a nested latent representation and where at least a first sub-band of frequencies overlaps with at least a second sub-band of frequencies. The second sub-band of frequencies includes additional frequencies not included in the first sub-band of frequencies. The sub-bands of frequencies may include a first band of 0-5 hz, a second band of 0-20 hz, and a third band of 0-150 hz. The input electrocardiogram is expressed in a time-domain. The input electrocardiogram may include a plurality of channels respectively associated with a plurality of electrocardiographic leads; and where the machine-learned encoder model is configured to individually process the plurality of channels. The prediction may include a disease prediction or a diagnostic prediction. The computing system may include of a mobile user computing device and where the machine-learned encoder model and the machine-learned prediction model are executed on-device on the mobile user computing device. The mobile user computing device may include a wearable computing device. The sub-bands of frequencies do not overlap. The latent representation may include a nested latent representation and where at least a first subset of representation dimensions is a subset of a second subset of representation dimensions. Different subsets of representation dimensions are separate from each other. Implementations of the described techniques may include hardware, a method or process, or computer software on a computer-accessible medium.

One general aspect includes a computer-implemented method to perform representation learning on electrocardiograms. The computer-implemented method also includes obtaining, by a computing system which may include one or more computing devices, an input electrocardiogram; processing, by the computing system, the input electrocardiogram with a machine-learned encoder model and a machine-learned projection model to generate a latent embedding of the input electrocardiogram; where the latent embedding of the input electrocardiogram may include a plurality of embedding dimensions, and where different subsets of the plurality of embedding dimensions encode information from the input electrocardiogram associated with different sub-bands of frequencies. The method also includes respectively processing, by the computing system, each subset of the plurality of embedding dimensions with a machine-learned decoder model to generate respective reconstructions of the input electrocardiogram; evaluating, by the computing system, a loss function that may include a frequency-domain reconstruction loss term that respectively compares masked frequency-domain versions of the input electrocardiogram to frequency-domain versions of the respective reconstructions of the input electrocardiogram, where each masked frequency-domain version of the input electrocardiogram has been masked to include only information contained in the corresponding frequency sub-band; and modifying, by the computing system, one or more values of one or more parameters of at least the encoder model based on the loss function. Other embodiments of this aspect include corresponding computer systems, apparatus, and computer programs recorded on one or more computer storage devices, each configured to perform the actions of the methods.

Implementations may include one or more of the following features. The computer-implemented method may include: generating, by the computing system, a masked version of the input electrocardiogram; where processing, by the computing system, the input electrocardiogram with the machine-learned encoder model and the machine-learned projection model may include processing, by the computing system, the masked version of the input electrocardiogram with the machine-learned encoder model and the machine-learned projection model. The computing system may include: processing the original unmasked version of the input electrocardiogram with the machine-learned encoder model and the machine-learned projection model to generate a second, different latent representation of the input electrocardiogram; evaluating an additional loss term that measures a similarity between the latent representation generated by processing the masked version of the input electrocardiogram and the second, different latent representation generated by processing the original unmasked version of the input electrocardiogram; and modifying, by the computing system, one or more values of one or more parameters of at least the encoder model based on the additional loss term. The additional loss term may include a variance-invariance-covariance regularization loss term. Evaluating, by the computing system, the loss function may include generating, by the computing system the masked frequency-domain version of the input electrocardiogram for each frequency sub-band, where generating, by the computing system the masked frequency-domain version of the input electrocardiogram for each frequency sub-band may include: performing, by the computing system, a forward Fourier transform on the input electrocardiogram to generate a ground truth frequency-domain representation of the input electrocardiogram; and for each frequency sub-band: applying, by the computing system, a sub-band-specific mask to the ground truth frequency-domain representation of the input electrocardiogram to generate the masked frequency-domain version of the input electrocardiogram for the frequency sub-band; where the sub-band-specific mask for each frequency sub-band masks data for frequencies that are not included in the frequency sub-band. The loss function further may include a time-domain reconstruction loss term that respectively compares time-domain inversions of the masked frequency-domain versions of the input electrocardiogram to time-domain inversions of the frequency-domain versions of the respective reconstructions of the input electrocardiogram. The latent representation may include a nested latent representation and where at least a first sub-band of frequencies overlaps with at least a second sub-band of frequencies. The latent representation may include a nested latent representation and where at least a first subset of representation dimensions is a subset of a second subset of representation dimensions. Implementations of the described techniques may include hardware, a method or process, or computer software on a computer-accessible medium.

One general aspect includes a computer-implemented method to perform representation learning on electrocardiograms. The computer-implemented method includes obtaining, by a computing system may include one or more computing devices, an input electrocardiogram; processing, by the computing system, the input electrocardiogram with a machine-learned encoder model and a machine-learned projection model to generate a mask-free latent embedding of the input electrocardiogram; generating, by the computing system, a masked version of the input electrocardiogram; processing, by the computing system, the masked version of the input electrocardiogram with the machine-learned encoder model and the machine-learned projection model to generate a mask-present latent embedding of the masked version of the input electrocardiogram; evaluating a loss term that measures a similarity between the mask-free latent representation and the mask-present latent representation; and modifying, by the computing system, one or more values of one or more parameters of at least the encoder model based on the loss term. Other embodiments of this aspect include corresponding computer systems, apparatus, and computer programs recorded on one or more computer storage devices, each configured to perform the actions of the methods.

Implementations may include one or more of the following features. The computer-implemented method where the loss term may include a variance-invariance-covariance regularization loss term. Implementations of the described techniques may include hardware, a method or process, or computer software on a computer-accessible medium.

One general aspect includes a computing system configured to generate predictions from time-domain signals. The computing system also includes one or more processors; and one or more non-transitory computer-readable media that collectively store: a machine-learned encoder model configured to process an input time-domain signal to generate, as an output of the machine-learned encoder model, at least a portion of a latent representation of the input time-domain signal, where the latent representation of the input time-domain signal may include a plurality of representation dimensions, where a plurality of different subsets of the plurality of representation dimensions encode information from the input time-domain signal associated with a plurality of different sub-bands of frequencies; a machine-learned prediction model configured to process at least the portion of the latent representation to generate, as an output of the machine-learned prediction model, a prediction; and instructions that, when executed by the one or more processors, cause the computing system to perform operations, the operations may include: obtaining the input time-domain signal; processing the input time-domain signal with the machine-learned encoder model to generate at least the portion of the latent representation of the input time-domain signal; processing at least the portion of the latent representation with the machine-learned prediction model to generate the prediction; and providing the prediction as an output. Other embodiments of this aspect include corresponding computer systems, apparatus, and computer programs recorded on one or more computer storage devices, each configured to perform the actions of the methods.

Implementations may include one or more of the following features. The computing system where the latent representation may include a nested latent representation and where at least a first sub-band of frequencies overlaps with at least a second sub-band of frequencies. The second sub-band of frequencies includes additional frequencies not included in the first sub-band of frequencies. Different subsets of representation dimensions are separate from each other. The sub-bands of frequencies may include a first band of 0-5 hz, a second band of 0-20 hz, and a third band of 0-150 hz. The input time-domain signal is expressed in a time-domain. The input time-domain signal may include a plurality of channels respectively associated with a plurality of electrocardiographic leads; and where the machine-learned encoder model is configured to individually process the plurality of channels. The prediction may include a disease prediction or a diagnostic prediction. The computing system may consist of a mobile user computing device and where the machine-learned encoder model and the machine-learned prediction model are executed on-device on the mobile user computing device. The mobile user computing device may include a wearable computing device. The sub-bands of frequencies do not overlap. The latent representation may include a nested latent representation and where at least a first subset of representation dimensions is a subset of a second subset of representation dimensions. Implementations of the described techniques may include hardware, a method or process, or computer software on a computer-accessible medium.

One general aspect includes a computer-implemented method to perform representation learning on time-domain signals. The computer-implemented method also includes obtaining, by a computing system may include one or more computing devices, an input time-domain signal; processing, by the computing system, the input time-domain signal with a machine-learned encoder model and a machine-learned projection model to generate a latent embedding of the input time-domain signal; where the latent embedding of the input time-domain signal may include a plurality of embedding dimensions, and where different subsets of the plurality of embedding dimensions encode information from the input time-domain signal associated with different sub-bands of frequencies. The method also includes respectively processing, by the computing system, each subset of the plurality of embedding dimensions with a machine-learned decoder model to generate respective reconstructions of the input time-domain signal; evaluating, by the computing system, a loss function that may include a frequency-domain reconstruction loss term that respectively compares masked frequency-domain versions of the input electrocardiogram to frequency-domain versions of the respective reconstructions of the input time-domain signal, where each masked frequency-domain version of the input electrocardiogram has been masked to include only information contained in the corresponding frequency sub-band; and modifying, by the computing system, one or more values of one or more parameters of at least the encoder model based on the loss function. Other embodiments of this aspect include corresponding computer systems, apparatus, and computer programs recorded on one or more computer storage devices, each configured to perform the actions of the methods.

Implementations may include one or more of the following features. The computer-implemented method may include: generating, by the computing system, a masked version of the input time-domain signal; where processing, by the computing system, the input time-domain signal with the machine-learned encoder model and the machine-learned projection model may include processing, by the computing system, the masked version of the input time-domain signal with the machine-learned encoder model and the machine-learned projection model. The computing system may include: processing the original unmasked version of the input time-domain signal with the machine-learned encoder model and the machine-learned projection model to generate a second, different latent representation of the input time-domain signal; evaluating an additional loss term that measures a similarity between the latent representation generated by processing the masked version of the input time-domain signal and the second, different latent representation generated by processing the original unmasked version of the input time-domain signal; and modifying, by the computing system, one or more values of one or more parameters of at least the encoder model based on the additional loss term. The additional loss term may include a variance-invariance-covariance regularization loss term. Evaluating, by the computing system, the loss function may include generating, by the computing system the masked frequency-domain version of the input electrocardiogram for each frequency sub-band, where generating, by the computing system the masked frequency-domain version of the input electrocardiogram for each frequency sub-band may include: performing, by the computing system, a forward Fourier transform on the input time-domain signal to generate a ground truth frequency-domain representation of the input time-domain signal; and for each frequency sub-band: applying, by the computing system, a sub-band-specific mask to the ground truth frequency-domain representation of the input time-domain signal to generate the masked frequency-domain version of the input electrocardiogram for the frequency sub-band; where the sub-band-specific mask for each frequency sub-band masks data for frequencies that are not included in the frequency sub-band. The loss function further may include a time-domain reconstruction loss term that respectively compares time-domain inversions of the masked frequency-domain versions of the input electrocardiogram to time-domain inversions of the frequency-domain versions of the respective reconstructions of the input time-domain signal. The latent representation may include a nested latent representation and where at least a first sub-band of frequencies overlaps with at least a second sub-band of frequencies. The latent representation may include a nested latent representation and where at least a first subset of representation dimensions is a subset of a second subset of representation dimensions. Implementations of the described techniques may include hardware, a method or process, or computer software on a computer-accessible medium.

One general aspect includes a computer-implemented method to perform representation learning on time-domain signals. The computer-implemented method includes obtaining, by a computing system may include one or more computing devices, an input time-domain signal; processing, by the computing system, the input time-domain signal with a machine-learned encoder model and a machine-learned projection model to generate a mask-free latent embedding of the input time-domain signal; generating, by the computing system, a masked version of the input time-domain signal; processing, by the computing system, the masked version of the input time-domain signal with the machine-learned encoder model and the machine-learned projection model to generate a mask-present latent embedding of the masked version of the input time-domain signal; evaluating a loss term that measures a similarity between the mask-free latent representation and the mask-present latent representation; and modifying, by the computing system, one or more values of one or more parameters of at least the encoder model based on the loss term. Other embodiments of this aspect include corresponding computer systems, apparatus, and computer programs recorded on one or more computer storage devices, each configured to perform the actions of the methods.

Implementations may include one or more of the following features. The computer-implemented method where the loss term may include a variance-invariance-covariance regularization loss term. Implementations of the described techniques may include hardware, a method or process, or computer software on a computer-accessible medium.

### BRIEF DESCRIPTION OF THE DRAWINGS

FIG. 1 is a graphical diagram illustrating an example technique for training machine-learning models to generate frequency-focused latent representations of electrocardiograms according to example implementations of aspects of the present disclosure;

FIG. 2 is a graphical diagram illustrating an example technique for generating latent representations of electrocardiograms according to example implementations of aspects of the present disclosure;

FIG. 3 is a graphical diagram illustrating an example technique for generating latent embeddings of electrocardiograms according to example implementations of aspects of the present disclosure;

FIG. 4 is a graphical diagram illustrating an example technique for generating reconstructions of electrocardiograms according to example implementations of aspects of the present disclosure;

FIG. 5 is a graphical diagram illustrating an example loss functions for training according to example implementations of aspects of the present disclosure;

FIG. 6 is a flow chart diagram illustrating an example method for training a machine-learned model according to example implementations of aspects of the present disclosure;

FIG. 7 is a block diagram of an example processing flow for using machine-learned model(s) to process input(s) to generate output(s) according to example implementations of aspects of the present disclosure;

FIG. 8 is a block diagram of an example sequence processing model according to example implementations of aspects of the present disclosure;

FIG. 9 is a block diagram of an example technique for populating an example input sequence for processing by a sequence processing model according to example implementations of aspects of the present disclosure;

FIG. 10 is a block diagram of an example model development platform according to example implementations of aspects of the present disclosure;

FIG. 11 is a block diagram of an example training workflow for training a machine-learned model according to example implementations of aspects of the present disclosure;

FIG. 12 is a block diagram of an inference system for operating one or more machine-learned model(s) to perform inference according to example implementations of aspects of the present disclosure;

FIG. 13 is a block diagram of an example networked computing system according to example implementations of aspects of the present disclosure;

FIG. 14 is a block diagram of an example computing device according to example implementations of aspects of the present disclosure; and

FIG. 15 is a block diagram of an example computing device according to example implementations of aspects of the present disclosure.

### DETAILED DESCRIPTION

Example aspects of the present disclosure are directed to computing systems and methods that can enhance the analysis and interpretation of electrocardiograms (ECGs) by employing a machine-learned model to generate latent representations of ECGs that encode frequency-based information contained in the ECG.

More particularly, traditional ECG analysis can include variability and inaccuracies and existing approaches either do not utilize or under-utilize frequency-based information contained in the ECG, particularly as relates to improving the interpretability of the predictive analysis.

In contrast, the technology described herein can train a machine-learned model (e.g., an “encoder model”) to generate a latent representation of an input ECG, a process which can be referred to as “representation learning”. This latent representation can be useful for many different downstream tasks. For example, another machine-learned model (e.g., a “prediction model”) can make a prediction or inference based on the latent representation. For example, the prediction can be a diagnostic prediction or other health-related inference

Specifically, example computing systems can include a machine-learned encoder model and a prediction model. The encoder model can process an input ECG to generate a latent representation. The latent representation can include a plurality of representation dimensions which can be organized into a plurality of different subsets. According to an aspect of the present disclosure, each subset of the representation dimensions can encode information associated with different sub-bands of frequencies. For example, one subset of the representation dimensions can encode information represented by lower frequencies. For example, this lower frequency information can be beneficial for identifying features associated with certain lower frequency components of an ECG signal. Similarly, another subset of the representation dimensions can encode information represented by higher frequencies of the ECG signal. For example, this higher frequency information can be beneficial for identifying features associated with certain higher frequency components of the ECG signal.

In some implementations, during training or representation learning, the system can include also a machine-learned decoder model that operates in conjunction with the encoder to reconstruct the ECG signal from the latent embeddings. The decoder can process each subset of the embedding dimensions to generate reconstruction(s) of the ECG signal corresponding to specific frequency bands. These reconstructions can be compared to frequency-band-specific information extracted from the original input ECG, thereby providing a useful training signal for the encoder to learn to create frequency-specific representations.

Specifically, in some implementations, the system can utilize one or more loss functions during training to enhance the quality of the latent representations. These can comprise frequency-domain and/or time-domain reconstruction losses, which can assist in improving the accuracy with which the different subsets of the latent representations encode information from the original ECG signals associated with specified frequency ranges. According to another aspect, a variance-invariance-covariance regularization loss can be employed to promote consistency and diversity among the embeddings.

After training, the encoder model can be paired with a prediction model. For example, the prediction model can utilize some or all of the encoded frequency-specific subsets of the latent representation to perform tasks such as diagnosing specific cardiac conditions based on characteristic frequency patterns observed in the ECG data. By making predictions across different combinations of frequency bands that are relevant to certain conditions, the prediction model can offer more targeted, accurate, and/or interpretable diagnostic outputs.

The proposed systems and methods can be implemented in a number of different computational environments. In one example, the proposed models can be deployed on mobile and/or wearable devices, enabling real-time, on-device processing of ECG data. This feature can improve applications that require immediate medical diagnostics and monitoring, offering support directly at the point of care without necessitating extensive hardware.

Thus, the present disclosure provides systems and methods for ECG analysis that are computationally efficient and interpretable, which can improve diagnostic accuracy and patient outcomes in clinical settings.

More particularly, one example aspect is directed to a machine-learned encoder model that is trained to generate frequency-specific latent representations. The encoder model can be configured to process an input ECG to generate a latent representation, which can include a plurality of representation dimensions. Each of a number of different subsets of the dimensions can encode information associated with different sub-bands of frequencies from the ECG. For instance, one subset of dimensions can encode low-frequency information beneficial for analyzing the P-wave or T-wave, while another subset can encode higher frequency information relevant to the QRS complex. This configuration allows for a segmented analysis of the ECG, which can improve the interpretability of predictions relating to various cardiac phenomena occurring at different frequency ranges.

Specifically, in some implementations, a machine-learned prediction model can be configured to process at least a portion of the latent representation generated by the encoder model to produce a prediction. This prediction can pertain to various diagnostics or other health-related conditions, such as predictions relating to arrhythmias or heart failure, based on the encoded information within the different frequency bands of the ECG data. For example, the prediction model can utilize specific subsets of the latent representation that correspond to specific frequency ranges for diagnosing atrial fibrillation or ventricular hypertrophy. Thus, the flexibility of the latent representation enables the larger model constellation to be adapted for different diagnostic tasks by focusing on the relevant portions of the latent representation pertinent to each specific cardiac condition.

According to another aspect of the present disclosure, in some implementations, the latent representation can be a “nested” latent representations. In a nested representation, different subsets of the representation dimension can correspond to sub-bands of frequencies which overlap with each other. For example, a first sub-band can capture frequencies from 0 to 5 Hz, which can be beneficial for analyzing lower frequency components such as the T-wave. A second sub-band can extend this range to include frequencies up to 20 Hz, thereby incorporating additional information pertinent to the P-wave and early components of the QRS complex. This overlapping of frequency bands can be advantageous in scenarios where multiple cardiac phenomena interact or manifest over adjacent frequency ranges, thus providing a more interpretable understanding of the ECG data.

However, in other implementations, the latent representation of the electrocardiogram can be configured such that the sub-bands of frequencies do not overlap, and different subsets of representation dimensions remain distinct. This configuration facilitates a clear delineation of frequency-specific information, with each subset of dimensions dedicated to a distinct frequency band. For instance, one subset can encode only the low frequencies (0-5 Hz) and another can encode the mid-range frequencies (5-20 Hz), without any overlap. This separation can be beneficial for applications that require precise frequency-specific analysis, as it helps to prevent the mixing of information from different frequency ranges. For example, this approach can facilitate more accurate identification and analysis of specific cardiac events that are best observed within narrow frequency ranges.

In some implementations, the prediction output generated by the computing system can include disease predictions or diagnostic predictions based on the processed ECG data. For example, the system can utilize detailed frequency-specific latent representations to predict the presence of conditions such as atrial fibrillation or ventricular hypertrophy. This capability allows healthcare providers to receive diagnostic information that can improve the timeliness and accuracy of interventions and the personalization of treatment plans. Additionally, in some implementations, the system can be configured to predict the severity or stage of a detected condition, thereby providing further insights that can be beneficial for managing patient care.

In some implementations, the proposed models can be deployed on a mobile user computing device, such as a wearable computing device, where both the machine-learned encoder model and the machine-learned prediction model are executed on-device. This configuration can facilitate real-time processing and analysis of ECG data directly on the wearable device, enabling immediate feedback and monitoring of the user's cardiac health. For instance, a smartwatch equipped with ECG sensors can continuously analyze heart rhythms and provide alerts for abnormalities like arrhythmias or signs of potential cardiac events.

Additional aspects of the present disclosure are directed to techniques for performing representation learning on electrocardiograms. Some example representation learning techniques can include obtaining an input electrocardiogram via a computing system, which then processes this input with a machine-learned encoder model and a machine-learned projection model to generate a latent embedding. This embedding can include multiple dimensions, with each of a number of different subsets of the embedding dimensions encoding information from different frequency sub-bands of the electrocardiogram. Subsequently, the computing system can process each subset of these embedding dimensions with a machine-learned decoder model to generate reconstructions of the input electrocardiogram.

A loss function can be utilized to evaluate the performance of the encoder and decoder models. One example loss function can include a frequency-domain reconstruction loss term. This term can compare masked frequency-domain versions of the original electrocardiogram with those of the reconstructions, with each version containing only the information from its corresponding frequency sub-band.

Based on the evaluation of the loss function(s), the computing system can modify one or more parameters of the encoder model to improve the performance of the encoder model at a subsequent iteration. The loss can also be applied to the other models as well, for example, in an end-to-end fashion. This parameter update can improve the accuracy and utility of the generated embeddings for subsequent diagnostic or monitoring tasks.

Specifically, in some implementations, the computing system can generate a masked version of the input ECG. This version can “mask” or obscures certain segments of the ECG data. The masking process can mimic missing or obscured data points that might occur in practical scenarios. The system can then process this masked version with the machine-learned encoder model, the machine-learned projection model, and the machine-learned decoder model, as described above.

Thus, the reconstruction loss(es) can be evaluated based on reconstructions generated from an embedding created from the masked version of the input ECG. By training the models on this masked data, the system can improve the robustness of the models, enabling them to handle incomplete or noisy ECG data more effectively. This process is beneficial for improving the reliability and accuracy of the model when faced with suboptimal or incomplete input data, which is not uncommon in medical settings.

In some implementations, reconstruction loss term(s) can include a frequency-domain reconstruction loss. Evaluating the frequency-domain reconstruction loss can include generating a masked frequency-domain version of the input electrocardiogram for each frequency sub-band. This can include performing a forward Fourier transform on the input electrocardiogram to yield a frequency-domain representation of the original input. Following this, for each designated frequency sub-band, the computing system can apply a sub-band-specific mask to the frequency-domain representation. This masking process selectively incorporates only the data relevant to the specific frequency sub-band (e.g., by masking the data outside the sub-band), thereby isolating the desired frequency components while omitting others. For example, should the frequency sub-band be defined for 0-5 Hz, the mask will exclude all frequency components outside this range. The frequency-domain reconstruction generated from a particular subset of the latent representation can then be compared to the corresponding masked frequency-domain version of the input electrocardiogram for the same frequency sub-band. In this fashion, the encoder can learn to encode frequency-band-specific information into the particular subset of the latent representation.

In some implementations, the loss function can additionally or alternatively include a time-domain reconstruction loss term. This term can compare time-domain inversions of the masked frequency-domain versions of the input electrocardiogram with time-domain inversions of the frequency-domain versions of the respective reconstructions of the input electrocardiogram. Specifically, after the frequency-domain manipulations and masking are completed as described above with reference to the frequency-domain reconstruction loss term, both the reconstructed versions and the masked frequency-domain versions of the input electrocardiogram can be converted back to the time-domain (e.g., after which they can be referred to as “time-domain inversions”). The time-domain reconstruction loss term then measures the discrepancies between these time-domain inversions. This comparison can improve the likelihood that the reconstructed signal still retains important time-domain characteristics of the original signal.

Furthermore, in some implementations, the computing system can process both the original, unmasked version of the input ECG and the masked version to generate two distinct latent representations. An additional loss term, for example which can be or include a variance-invariance-covariance regularization loss term, can be evaluated to measure the similarity between these two latent representations. This additional loss term can improve the likelihood that the model's response to the masked input does not deviate significantly from its response to the unmasked input, thereby enhancing the model's ability to generalize across varying input conditions. Specifically, the variance-invariance-covariance regularization can aid in maintaining the variance across the model's outputs, improving invariance to less informative variations in the input, and reducing redundancy in the representations. Adjusting the model parameters based on this additional loss term can further improve the model's performance.

The techniques described in the present disclosure are primarily described with reference to the processing and analysis of ECG signals. However, the proposed techniques and methodologies can also be applied to a variety of other time-domain signals. This adaptability leverages the principles of signal processing, machine learning, and pattern recognition that are incorporated within the techniques, which are not confined to cardiac signals alone. Some examples of other time-domain signals to which the proposed techniques can be applied are provided in the paragraphs that follow. Several other time-domain signals are also described further below.

As one example, pulse or heart rate signals, which are important indicators of cardiovascular health similar to ECGs, can be analyzed using the described encoder and decoder models. These signals, which often vary in frequency and amplitude akin to ECGs, can benefit from the same frequency-domain analysis and time-domain reconstruction techniques to detect anomalies or patterns that can indicate health issues or stress levels.

Another example is respiratory signals (e.g., derived from spirometry tests), which assess the volume of air inhaled and exhaled by the lungs and/or breathing rate (e.g., breaths per minute). The variability in breathing rate and/or other spirometric data such as tidal volume and peak expiratory flow can be encoded into latent representations, facilitating detailed analysis and monitoring of respiratory conditions. In some implementations, the capability to mask certain frequency bands or utilize specific subsets of data to concentrate on particular aspects of the breathing pattern can be beneficial in diagnosing and managing different pulmonary conditions such as asthma or chronic obstructive pulmonary disease (COPD).

As another example, the proposed technology can be adapted to analyze sleep scores, which are generally calculated from a variety of physiological signals gathered during sleep, including heart rate, breathing patterns, and body movements. By utilizing a latent representation which enables frequency-focused analysis, subtle variations in sleep quality or stages can be detected with greater accuracy, potentially improving sleep assessment tools and personalized sleep management strategies.

As another example, exercise signals, such as those derived from accelerometers measuring steps or other movements, can be the subject of the proposed techniques. The time-series data generated from physical activities can be analyzed to assess the intensity, regularity, and type of movements, which can contribute to improved fitness tracking and personalized exercise recommendations. The employment of machine learning models to process and predict based on these signals can facilitate the creation of more interactive and responsive health and fitness applications.

The proposed systems and methods provide a number of technical effects and benefits. As one example, the proposed methods for processing ECG signals can enhance the efficiency and effectiveness of cardiac diagnostics. By modeling the frequency structures inherent in ECG data, the technology can capture essential physiological signals that are beneficial for accurate health assessments. Therefore, the proposed techniques improve the functionality of medical diagnostic tools and devices.

Specifically, as one technical effect, the generation of representations corresponding to different frequency bands can improve the interpretability of data, which is beneficial in the field of medical diagnostics and research. This method can permit a detailed analysis of how various components of a signal, isolated based on their frequency characteristics, can contribute to diverse physiological or pathological outcomes. In some implementations, by segmenting the data into distinct frequency bands, the technology can enable a detailed comparison of these bands either among themselves or with different types of biomedical data, such as genomic data.

As an example, in some implementations, specific frequency bands in an ECG can correlate with genetic markers associated with heart diseases. By isolating these bands and analyzing their representations independently, researchers and clinicians can improve the accuracy of pinpointing the influence of particular frequencies on health outcomes. This capability can be beneficial for understanding complex biological interactions and for developing targeted therapeutic strategies based on a deeper understanding of disease mechanisms.

Additionally, this method of comparison across various frequency bands can illustrate which bands are beneficial for certain diagnoses and which are less informative. This information can refine the diagnostic process by concentrating on the most relevant data and can reduce computational overhead by potentially disregarding less pertinent frequency bands.

As another example technical effect, the proposed technology can enable the deployment of a model that utilizes only certain subsets of data associated with frequency bands that have been deemed beneficial for specific prediction tasks. In some implementations, this selective approach can reduce the overall size of the data representation necessary for accurate predictions. Consequently, this reduction can lead to decreased consumption of computational resources, which can be advantageous in real-time processing environments or devices with limited processing capabilities, such as wearable health monitors. In such contexts, optimizing resource utilization can improve device performance and extend its operational lifespan. Therefore, the technology can both enhance the precision of medical diagnostics and improve the computational efficiency of the systems in which it is implemented.

In particular, as one example, the application of a correlation penalty in some example implementations allows the representations to be both compact and of high rank, which can reduce the computational load and the model size required for processing. This high effective rank indicates that the features learned by the model are both decorrelated and diverse. In some implementations, decorrelation among features can be beneficial as it can reduce redundant information, enabling the model to use its capacity more efficiently to capture unique and informative aspects of the data. The diversity in the features can improve the model's ability to encapsulate a wide range of information from the ECG signals.

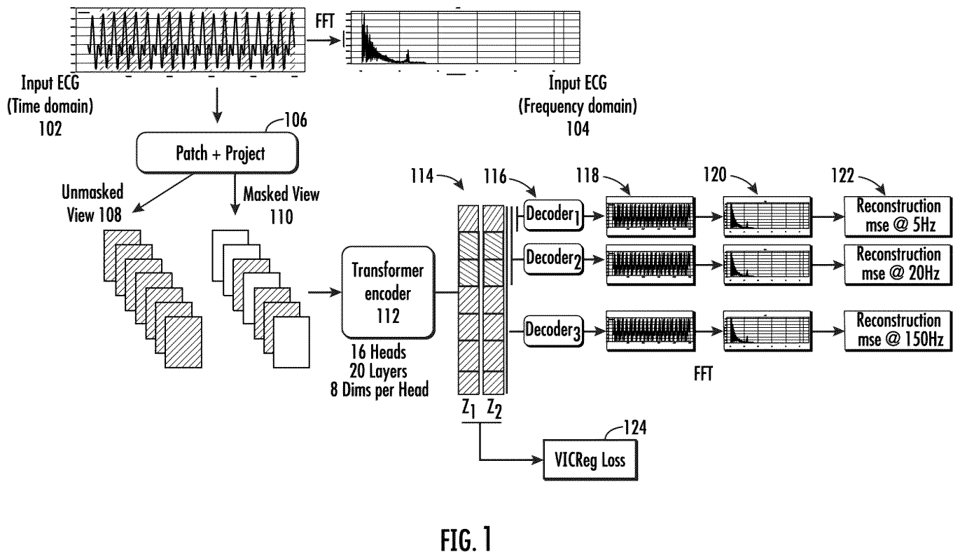

FIG. 1 illustrates an example system architecture 100 for performing representation learning on electrocardiogram (ECG) data to generate frequency-specific latent representations, in accordance with one or more example aspects of the present disclosure.

In some implementations, during an initial data preparation stage, a computing system can obtain an input ECG, such as the input time domain ECG 102. The input electrocardiogram can be expressed in a time-domain and, in some examples, can be obtained from a source such as a medical device (e.g., a hospital-grade ECG monitor, an ambulatory monitor), a wearable computing device (e.g., a smartwatch, a fitness tracker, a smart patch), or a data repository (e.g., a medical database, a cloud storage system). As one example, the input time domain ECG 102 can comprise a multi-channel signal, such as a standard 12-lead ECG, sampled at a rate of 500 hertz (Hz) over a 10-second interval, which can result in a data structure with 5000 discrete timesteps per channel.

A patch and project block 106 can be configured to process the raw time-series data. For instance, the patch and project block 106 can tokenize the signal by dividing the input time domain ECG 102 into a sequence of non-overlapping patches. As an illustrative example, the 5000 timesteps can be segmented into 10 consecutive patches, where each patch can comprise 500 samples. Following the patching operation, the patches can be projected into a shared dimensional space using, for example, a single-layer multilayer perceptron (MLP).

Subsequent to patching and projection, the system can generate two distinct data streams to facilitate a self-supervised learning process. For example, an unmasked view 108 can be generated, which can represent the original sequence of projected patches from the input time domain ECG 102. Additionally, the system can generate a masked version of the input electrocardiogram, referred to as the masked view 110. To generate the masked view 110, a masking function can be applied to the sequence of patches, which can, for instance, randomly set a fraction of the patches to a zero-value. This process can create two related but distinct inputs for a downstream transformer encoder 112 (e.g., a vision transformer, a multi-head attention-based network, or another suitable transformer architecture).

Concurrently, or as a separate preliminary step, the system can perform a forward Fourier transform (e.g., a Fast Fourier Transform or FFT) on the input time domain ECG 102 to generate a ground truth frequency-domain representation, shown as the input frequency domain ECG 104. This frequency-domain representation can be utilized during a training phase for the evaluation of a reconstruction loss function.

In operation, the transformer encoder 112, which may be implemented as a machine-learned encoder model, is configured to receive and process projected patches generated from both an unmasked view 108 and a masked view 110. Specifically, the transformer encoder 112 can be configured to process the projected patches corresponding to the unmasked view 108 to generate a mask-free latent representation of the input electrocardiogram, and to process, in parallel or sequentially, the projected patches corresponding to the masked view 110 to generate a mask-present latent representation.

In some implementations, the transformer encoder 112 may be configured with a multi-layer architecture, such as an architecture comprising 20 layers, with each layer including multiple self-attention heads, for example, 16 self-attention heads per layer. Each attention head may be configured to operate on a specific vector dimension, such as a dimension of 8, to facilitate the learning of varied signal features.

The output of the transformer encoder 112 can include the latent representations 114, wherein a representation for each processed patch can comprise a plurality of representation dimensions, resulting in an example representation of size 128 in some examples. Following this encoding step, the set of latent representations 114 can be aggregated, for instance, by performing a mean-pooling operation across all patch representations and across all electrocardiographic leads. The resulting aggregated representation can then be passed through a final projector component to generate a final embedding for each view. These embeddings can be subsequently utilized for calculating the VICReg loss 124, which can evaluate a similarity between the mask-free latent representation and the mask-present latent representation as part of a model training process.

Subsequent to generation by the transformer encoder 112, the latent representations 114 can be processed by the multi-level decoder 116. The multi-level decoder 116, which may be implemented as a machine-learned decoder model (e.g., a neural network, a transformer-based decoder, or another suitable model), can be configured to process different subsets of the plurality of representation dimensions to generate corresponding reconstructions of the input electrocardiogram.

In some implementations, the architecture of the decoder 116 may be a nested or Matryoshka-style architecture comprising a plurality of decoder heads, where each decoder head is configured to operate on a different subset of the representation dimensions from a latent representation 114. For example, the latent representation may comprise a nested latent representation wherein at least a first subset of representation dimensions is a subset of a second subset of representation dimensions. This structure can enable different subsets of the plurality of representation dimensions to encode information from the input electrocardiogram associated with a plurality of different sub-bands of frequencies.

As a non-limiting example, a first decoder head may process a first subset of dimensions (e.g., dimensions 1-32) associated with a first frequency sub-band (e.g., up to 5 Hz), a second decoder head may process a second, larger subset (e.g., dimensions 1-64) associated with a second frequency sub-band (e.g., up to 20 Hz), and a third decoder head may process a third, even larger subset (e.g., dimensions 1-128) associated with a third sub-band (e.g., up to 150 Hz). In such cases, the first sub-band of frequencies can overlap with the second sub-band of frequencies, and the second sub-band can include additional frequencies not included in the first sub-band. In other implementations, the sub-bands of frequencies may not overlap, and the different subsets of representation dimensions can be separate from each other. The output of each decoder head can be a reconstructed time domain signal 118, which can then be processed, for example via a Fast Fourier Transform (FFT), to generate a corresponding reconstructed frequency domain signal 120. These frequency-domain versions of the reconstructions of the input electrocardiogram can then be used for subsequent loss computation.

In some implementations, during a training phase for one or more models within the system architecture 100, a composite loss function can be evaluated to update model parameters. For instance, the composite loss function can include a reconstruction loss 122 and the variance-invariance-covariance regularization (VICReg) loss 124. The reconstruction loss 122 can include a frequency-domain reconstruction loss term that compares masked frequency-domain versions of the input electrocardiogram to frequency-domain versions of respective reconstructions of the input electrocardiogram. As one example, in computing the reconstruction loss 122, a comparison can be performed between a reconstructed frequency domain signal 120, which can be generated by the multi-level decoder 116, and the input frequency domain ECG 104 for a corresponding frequency sub-band. This comparison can be implemented, for example, as a mean squared error calculation (e.g., L_W-RECON) between a Fast Fourier Transform (FFT) of the reconstruction and a sub-band-specific masked version of the FFT of the original input ECG. In some implementations, the loss function can further include a time-domain reconstruction loss term.

Additionally, or as part of the composite function, the computing system can evaluate the VICReg loss 124, which can be configured to measure a similarity between a mask-free latent representation, derived from the unmasked view 108, and a mask-present latent representation, derived from the masked view 110, within the collection of latent representations 114. The VICReg loss term can be configured to promote certain properties on the embeddings. For example, an invariance component can encourage the representations from the masked and unmasked views to be similar. A variance component can maintain statistical variance across each embedding dimension in a batch, which can prevent the model from collapsing to a trivial solution. A covariance component can penalize correlation between different embedding dimensions to promote feature diversity. Based on the evaluation of the composite loss, the computing system can modify one or more values of one or more parameters of at least the encoder model (e.g., the transformer encoder 112) via a process such as backpropagation.

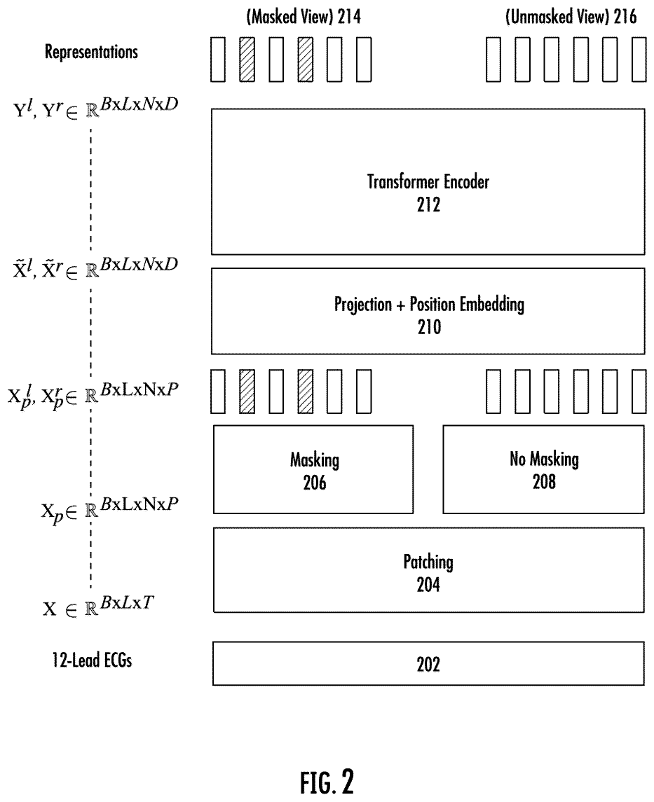

FIG. 2 illustrates a detailed block diagram of an example data processing pipeline that may be used to prepare input data for an encoder model, such as the transformer encoder 112 described with reference to FIG. 1. In some implementations, the pipeline may be configured to receive an input signal, such as one or more 12-lead ECGs 202. A patching module 204 (e.g., a tokenizer, a segmentation component) may be configured to segment the time-series data into a sequence of patches. This sequence of patches can then be processed to generate two parallel data streams. For instance, a first stream may be provided to a masking module 206, which can be configured to apply a mask to the patched data to generate a masked view 214. A second stream may be processed without a mask, as indicated by block 208, to generate an unmasked view 216. In some examples, both the masked view 214 and the unmasked view 216 can be provided to a projection and position embedding layer 210, which can be configured to project the patches into a shared dimensional space and add positional information. The resulting processed views may then be provided as input to a transformer encoder 212 (e.g., a multi-head attention-based network), which can be configured to generate respective latent representations for each view.

FIG. 3 illustrates an example data flow for generating embeddings from latent representations, in accordance with one or more example aspects of the present disclosure. This process may be performed, for example, to generate embeddings for the evaluation of a regularization loss, such as the VICReg loss 124 described with reference to FIG. 1. As shown in FIG. 3, the data flow may receive as input a mask-present representation 302 and a mask-free representation 304. In some implementations, these representations may be generated by an encoder (e.g., the transformer encoder 112) processing masked and unmasked views of an input signal, respectively. The representations 302 and 304 may be provided to a mean pooling module 306, which may be configured to aggregate the representations across a plurality of patches and/or input channels to generate pooled representations. The pooled representations may then be processed by a projection module 308 (e.g., a machine-learned projector model, such as a multi-layer perceptron). The projection module 308 may be configured to generate a corresponding mask-present embedding 310 from the pooled mask-present representation and a mask-free embedding 312 from the pooled mask-free representation. The embeddings 310 and 312 may then be utilized to evaluate a loss term that measures their similarity, which can be beneficial for training the encoder model to generate consistent representations.

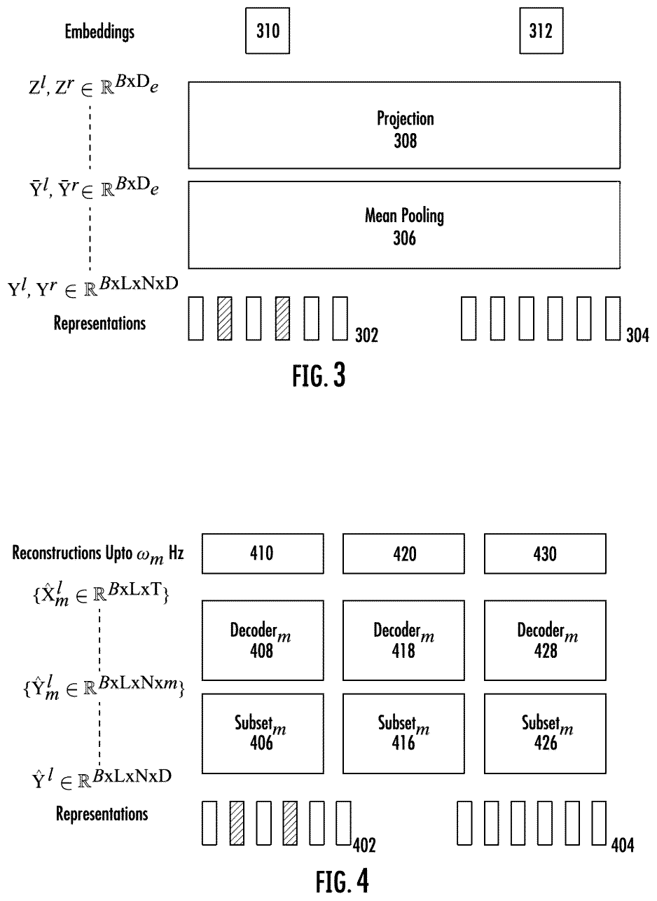

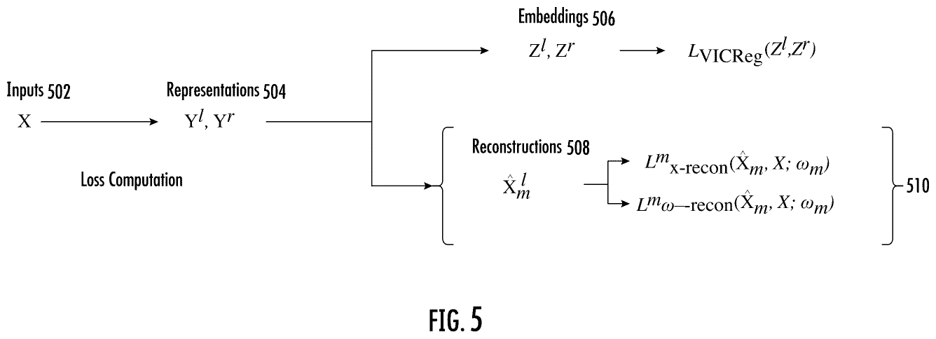

FIG. 4 illustrates an example architecture for a multi-level decoder, such as the multi-level decoder 116 described with reference to FIG. 1, which may be referred to as a “Matryoshka-style” decoder. In some implementations, the architecture is configured to receive a latent representation, such as a mask-present representation 402 generated from a masked input or a mask-free representation 404 generated from an unmasked input. As illustrated in the data flow, the latent representation (e.g., the mask-present representation 402) may be processed to generate a plurality of nested subsets 406, 416, and 426, which may be of increasing dimensionality. A plurality of decoders 408, 418, and 428, which can be implemented as individual decoder heads within a single model, are each configured to process a respective one of the subsets 406, 416, and 426. Each decoder can, in turn, generate a respective signal reconstruction 410, 420, and 430. This architectural approach allows each reconstruction to be associated with a different frequency sub-band, facilitating a training process where an encoder can learn to encode frequency-specific information into corresponding subsets of the latent representation.

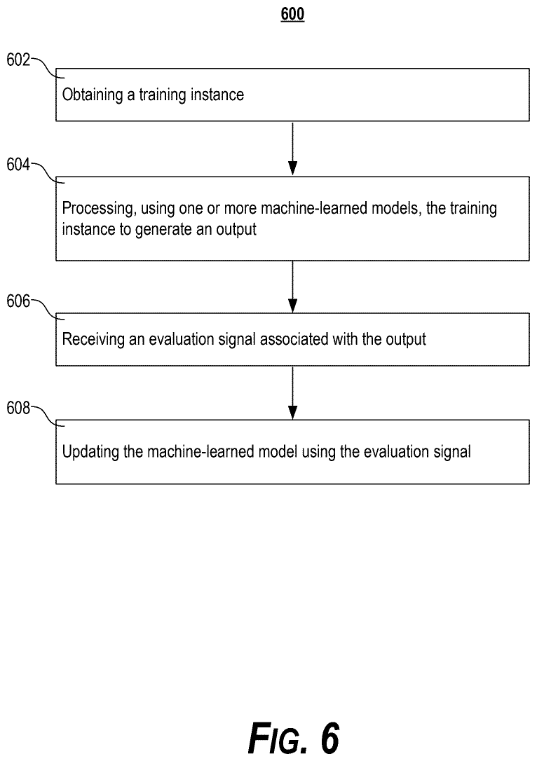

FIG. 5 illustrates a block diagram of an example loss computation process that may be used during the training of one or more machine-learned models, such as the models described with reference to FIG. 1. In some implementations, the process can receive one or more inputs 502 (e.g., an original signal X), which can be processed by an encoder model to generate latent representations 504. The representations 504 may then be utilized in parallel computational paths to calculate different loss terms. For instance, in a first path, the representations 504 may be processed by a projection model to generate embeddings 506. The embeddings 506 can then be used to calculate a regularization loss, such as a variance-invariance-covariance (VICReg) loss, which may be configured to promote consistency and diversity in the learned embeddings. In a second path, the representations 504 can be processed by a decoder model to generate one or more reconstructions 508. The reconstructions 508 may be compared against the original inputs 502 to calculate one or more reconstruction losses 510. As an example, the reconstruction losses 510 can include both time-domain and frequency-domain components. A combination of these loss terms can provide a training signal for modifying one or more parameters of the model(s).

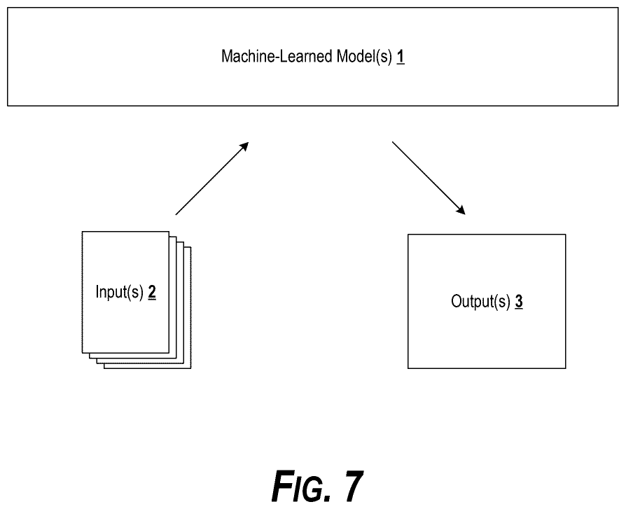

FIG. 6 depicts a flowchart of a method 600 for training one or more machine-learned models according to aspects of the present disclosure. One or more portion(s) of example method 600 can be implemented by a computing system that includes one or more computing devices such as, for example, computing systems described with reference to the other figures. Each respective portion of example method 600 can be performed by any (or any combination) of one or more computing devices. Moreover, one or more portion(s) of example method 600 can be implemented on the hardware components of the device(s) described herein, for example, to train one or more systems or models. FIG. 6 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6 is described with reference to elements/terms described with respect to other systems and figures for exemplary illustrated purposes and is not meant to be limiting. One or more portions of example method 600 can be performed additionally, or alternatively, by other systems.

At 602, example method 600 can include obtaining a training instance. A set of training data can include a plurality of training instances divided between multiple datasets (e.g., a training dataset, a validation dataset, or testing dataset). A training instance can be labeled or unlabeled. Although referred to in example method 600 as a “training” instance, it is to be understood that runtime inferences can form training instances when a model is trained using an evaluation of the model's performance on that runtime instance (e.g., online training/learning). Example data types for the training instance and various tasks associated therewith are described throughout the present disclosure.

At 604, example method 600 can include processing, using one or more machine-learned models, the training instance to generate an output. The output can be directly obtained from the one or more machine-learned models or can be a downstream result of a chain of processing operations that includes an output of the one or more machine-learned models.

At 606, example method 600 can include receiving an evaluation signal associated with the output. The evaluation signal can be obtained using a loss function. Various determinations of loss can be used, such as mean squared error, likelihood loss, cross entropy loss, hinge loss, contrastive loss, or various other loss functions. The evaluation signal can be computed using known ground-truth labels (e.g., supervised learning), predicted or estimated labels (e.g., semi-or self-supervised learning), or without labels (e.g., unsupervised learning). The evaluation signal can be a reward (e.g., for reinforcement learning). The reward can be computed using a machine-learned reward model configured to generate rewards based on output(s) received. The reward can be computed using feedback data describing human feedback on the output(s).

At 608, example method 600 can include updating the machine-learned model using the evaluation signal. For example, values for parameters of the machine-learned model(s) can be learned, in some embodiments, using various training or learning techniques, such as, for example, backwards propagation. For example, the evaluation signal can be backpropagated from the output (or another source of the evaluation signal) through the machine-learned model(s) to update one or more parameters of the model(s) (e.g., based on a gradient of the evaluation signal with respect to the parameter value(s)). For example, system(s) containing one or more machine-learned models can be trained in an end-to-end manner. Gradient descent techniques can be used to iteratively update the parameters over a number of training iterations. In some implementations, performing backwards propagation of errors can include performing truncated backpropagation through time. Example method 600 can include implementing a number of generalization techniques (e.g., weight decays, dropouts, etc.) to improve the generalization capability of the models being trained.

In some implementations, example method 600 can be implemented for training a machine-learned model from an initialized state to a fully trained state (e.g., when the model exhibits a desired performance profile, such as based on accuracy, precision, recall, etc.).

In some implementations, example method 600 can be implemented for particular stages of a training procedure. For instance, in some implementations, example method 600 can be implemented for pre-training a machine-learned model. Pre-training can include, for instance, large-scale training over potentially noisy data to achieve a broad base of performance levels across a variety of tasks/data types.

In some implementations, example method 600 can be implemented for fine-tuning a machine-learned model. Fine-tuning can include, for instance, smaller-scale training on higher-quality (e.g., labeled, curated, etc.) data. Fine-tuning can affect all or a portion of the parameters of a machine-learned model. For example, various portions of the machine-learned model can be “frozen” for certain training stages. For example, parameters associated with an embedding space can be “frozen” during fine-tuning (e.g., to retain information learned from a broader domain(s) than present in the fine-tuning dataset(s)). In some implementations, example method 600 uses adapter modules. Adapters can be small trainable layers that are inserted between pre-existing layers of a pre-trained model. During the fine-tuning process, the original parameters of the pre-trained model are typically frozen, and only the parameters of the adapters are updated.

In some implementations, example method 600 can be implemented to execute parameter-efficient fine-tuning methods, such as Low-Rank Adaptation (LoRA). LoRA can refine pre-trained models with minimal adjustments to the original parameters. This can be achieved by introducing trainable low-rank matrices that modify the behavior of the pre-trained weights without directly altering them. In some implementations, during fine-tuning, only these auxiliary matrices are updated, which significantly reduces the number of parameters that are trained.

An example fine-tuning approach includes reinforcement learning. Reinforcement learning can be based on user feedback on model performance during use.

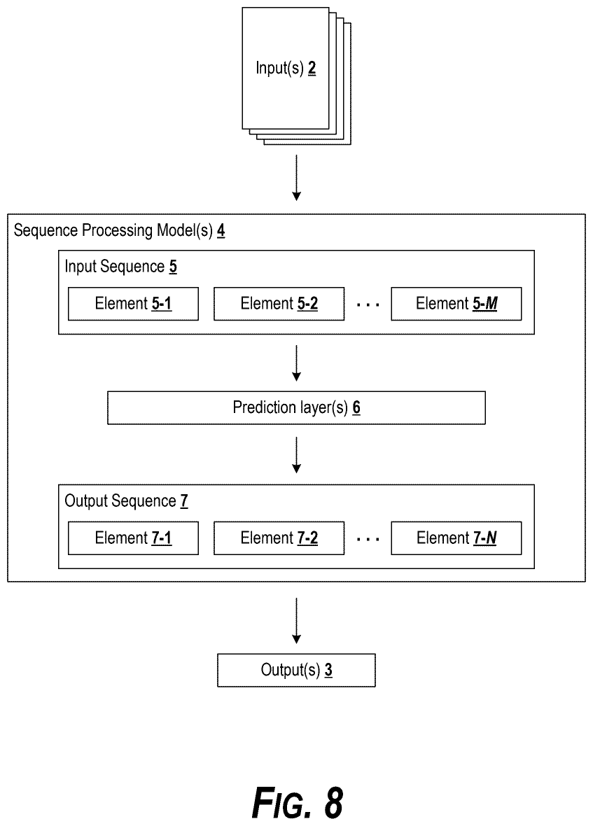

FIG. 7 is a block diagram of an example processing flow for using machine-learned model(s) 1 to process input(s) 2 to generate output(s) 3.

Machine-learned model(s) 1 can be or include one or multiple machine-learned models or model components. Example machine-learned models can include neural networks (e.g., deep neural networks). Example machine-learned models can include non-linear models or linear models. Example machine-learned models can use other architectures in lieu of or in addition to neural networks. Example machine-learned models can include decision tree based models, support vector machines, hidden Markov models, Bayesian networks, linear regression models, k-means clustering models, etc.

Machine-learned model(s) 1 can be or include, or otherwise be representative of any one or more of the machine-learned models described above with respect to the preceding figures. Example neural networks can include feed-forward neural networks, recurrent neural networks (RNNs), including long short-term memory (LSTM) based recurrent neural networks, convolutional neural networks (CNNs), diffusion models, generative-adversarial networks, or other forms of neural networks. Example neural networks can be deep neural networks. Some example machine-learned models can leverage an attention mechanism such as self-attention or cross attention. For example, some example machine-learned models can include multi-headed self-attention models, multi-query self-attention models, or other attention mechanisms.

Machine-learned model(s) 1 can include a single or multiple instances of the same model configured to operate on data from input(s) 2. Machine-learned model(s) 1 can include multiple different models or multiple different model portions configured to operate on data from input(s) 2.

Machine-learned model(s) 1 can include an ensemble of different models that can cooperatively interact to process data from input(s) 2. For example, a model ensemble can include multiple models that have different attributes (e.g., different architectures, trained with different recipes, etc.). The ensemble can output an overall output based on the individual outputs of the constituent models. In this manner, for instance, the diverse constituent models can work together to provide system-level robustness by effectively aggregating over individual strengths and weaknesses of any given model. The respective individual outputs can be combined in a weighted combination, using a voting or routing mechanism, or a learned output layer (e.g., one or more feedforward or fully-connected layers).

Machine-learned model(s) 1 can employ a mixture-of-experts structure. See, e.g., Zhou et al., Mixture-of-Experts with Expert Choice Routing, ARXIV:2202.09368v2 (Oct. 14, 2022). For example, different portions of a model can learn (explicitly or implicitly) different expertise areas, with pathways through the model being selected by a learned routing mechanism that engages the appropriate expert for a given input (e.g., a given portion of an input, such as on a per-token basis). For example, a feedforward network can be sparsely activated for a given portion of an input based on an output of a routing mechanism that processes the portion of the input. In this manner, for instance, the group of activated weights can form an “expert” that is selected by the router. On each forward pass, only a subset of the total model weights may be engaged, thereby decreasing a quantity of operations performed for processing a given input compared to a densely activated model. In this manner, for instance, the expressive and interpretive power of a high-parameter-count model can be achieved with more compute-efficient forward passes.

Input(s) 2 can generally include or otherwise represent various types of data. Input(s) 2 can include one type or many different types of data. Output(s) 3 can be data of the same type(s) or of different types of data as compared to input(s) 2. Output(s) 3 can include one type or many different types of data.

Example data types for input(s) 2 or output(s) 3 include natural language text data, software code data (e.g., source code, object code, machine code, or any other form of computer-readable instructions or programming languages), machine code data (e.g., binary code, assembly code, or other forms of machine-readable instructions that can be executed directly by a computer's central processing unit), assembly code data (e.g., low-level programming languages that use symbolic representations of machine code instructions to program a processing unit), genetic data or other chemical or biochemical data, image data, audio data, audiovisual data, haptic data, biometric data, medical data, financial data, statistical data, geographical data, astronomical data, historical data, sensor data generally (e.g., digital or analog values, such as voltage or other absolute or relative level measurement values from a real or artificial input, such as from an audio sensor, light sensor, displacement sensor, etc.), and the like. Data can be raw or processed and can be in any format or schema.

In multimodal inputs 2 or outputs 3, example combinations of data types include image data and audio data, image data and natural language data, natural language data and software code data, image data and biometric data, sensor data and medical data, etc. It is to be understood that any combination of data types in an input 2 or an output 3 can be present.

An example input 2 can include one or multiple data types, such as the example data types noted above. An example output 3 can include one or multiple data types, such as the example data types noted above. The data type(s) of input 2 can be the same as or different from the data type(s) of output 3. It is to be understood that the example data types noted above are provided for illustrative purposes only. Data types contemplated within the scope of the present disclosure are not limited to those examples noted above.

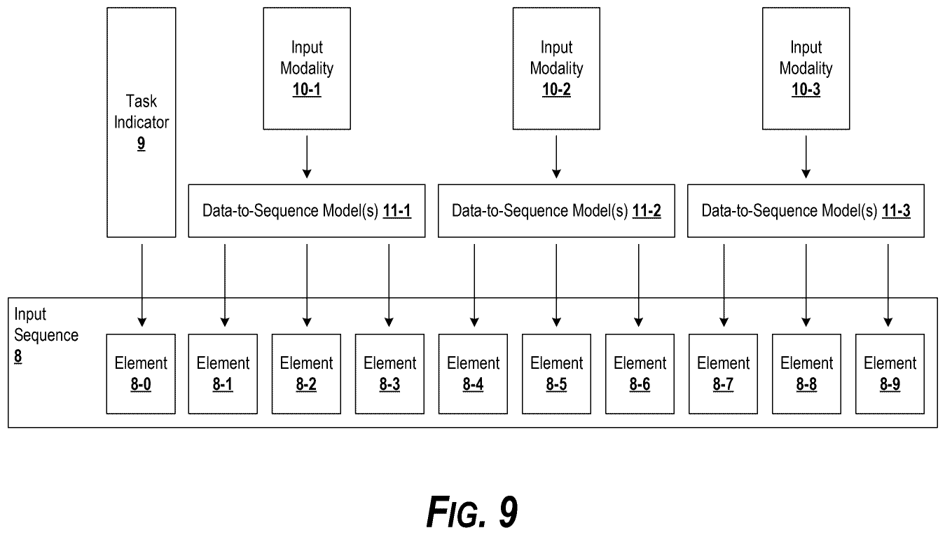

FIG. 8 is a block diagram of an example implementation of an example machine-learned model configured to process sequences of information. For instance, an example implementation of machine-learned model(s) 1 can include machine-learned sequence processing model(s) 4. An example system can pass input(s) 2 to sequence processing model(s) 4. Sequence processing model(s) 4 can include one or more machine-learned components. Sequence processing model(s) 4 can process the data from input(s) 2 to obtain an input sequence 5. Input sequence 5 can include one or more input elements 5-1, 5-2,. 5-M, etc. obtained from input(s) 2. Sequence processing model 4 can process input sequence 5 using prediction layer(s) 6 to generate an output sequence 7. Output sequence 7 can include one or more output elements 7-1, 7-2,. 7-N, etc. generated based on input sequence 5. The system can generate output(s) 3 based on output sequence 7.

Sequence processing model(s) 4 can include one or multiple machine-learned model components configured to ingest, generate, or otherwise reason over sequences of information. For example, some example sequence processing models are referred to as language models and can leverage language-based understandings across one or multiple modalities of input information. Sequence processing model(s) 4 can include relatively large models (e.g., more parameters, computationally expensive, etc.), which may be referred to as “Large Language Models” or LLMs. Sequence processing model(s) 4 can include relatively small models (e.g., fewer parameters, computationally lightweight, etc.), which may be referred to as “Small Language Models” or SLMs. Example language models include, for instance, models described in Gemma: Open Models Based on Gemini Research and Technology, GOOGLE, https://arxiv.org/abs/2403.08295; Gemma 2: Improving Open Language Models at a Practical Size, GOOGLE, https://arxiv.org/abs/2408.00118.

Sequence processing model(s) 4 can process one or multiple types of data simultaneously. Variations of language models that can perform joint vision and language tasks may be referred to as “Vision-Language Models,” or VLMs. Example VLMs include models described in PaliGemma: A versatile 3B VLM for transfer, GOOGLE, https://arxiv.org/abs/2407.07726; PaliGemma 2: A Family of Versatile VLMs for Transfer, GOOGLE, https://arxiv.org/abs/2412.03555; Flamingo: a Visual Language Model for Few-Shot Learning, GOOGLE, https://arxiv.org/abs/2204.14198; PaLI: A Jointly-Scaled Multilingual Language-Image Model, GOOGLE, https://arxiv.org/abs/2209.06794.

Sequence processing model(s) 4 can be multimodal. Example multimodal sequence processing models include, for instance, models described in Gemini: A Family of Highly Capable Multimodal Models, GOOGLE, https://arxiv.org/abs/2312.11805; Gemini 1.5: Unlocking multimodal understanding across millions of tokens of context, GOOGLE, https://arxiv.org/abs/2403.05530.

Other example sequence processing models can operate to generate outputs or receive inputs in specific domains, such as image domains, see, e.g., Dosovitskiy et al., An Image is Worth 16×16 Words: Transformers for Image Recognition at Scale, ARXIV:2010.11929v2 (Jun. 3, 2021), audio domains, see, e.g., Agostinelli et al., MusicLM: Generating Music From Text, ARXIV:2301.11325v1 (Jan. 26, 2023), biochemical domains, see, e.g., Jumper et al., Highly accurate protein structure prediction with AlphaFold, 596 Nature 583 (Aug. 26, 2021), by way of example.

In general, sequence processing model(s) 4 can obtain input sequence 5 using data from input(s) 2. For instance, input sequence 5 can include a representation of data from input(s) 2 in a format understood by sequence processing model(s) 4. One or more machine-learned components of sequence processing model(s) 4 can ingest the data from input(s) 2, parse the data into pieces compatible with the processing architectures of sequence processing model(s) 4 (e.g., via “tokenization”), and project the pieces into an input space associated with prediction layer(s) 6 (e.g., via “embedding”).

Sequence processing model(s) 4 can ingest the data from input(s) 2 and parse the data into a sequence of elements to obtain input sequence 5. For example, a portion of input data from input(s) 2 can be broken down into pieces that collectively represent the content of the portion of the input data. The pieces can provide the elements of the sequence.

Elements 5-1, 5-2, . . . 5-M can represent, in some cases, building blocks for capturing or expressing meaningful information in a particular data domain. For instance, the elements can describe “atomic units” across one or more domains. For example, for textual input source(s), the elements can correspond to groups of one or more words or sub-word components, such as sets of one or more characters.

For example, elements 5-1, 5-2, . . . 5-M can represent tokens obtained using a tokenizer. For instance, a tokenizer can process a given portion of an input source and output a series of tokens (e.g., corresponding to input elements 5-1, 5-2, . . . 5-M) that represent the portion of the input source. Various approaches to tokenization can be used. For instance, textual input source(s) can be tokenized using a byte-pair encoding (BPE) technique. See, e.g., Kudo et al., SentencePiece: A simple and language independent subword tokenizer and detokenizer for Neural Text Processing, PROCEEDINGS OF THE 2018 CONFERENCE ON EMPIRICAL METHODS IN NATURAL LANGUAGE PROCESSING (System Demonstrations), pages 66-71 (October 31-Nov. 4, 2018), https://aclanthology.org/D18-2012.pdf. Image-based input source(s) can be tokenized by extracting and serializing patches from an image.

In general, arbitrary data types can be serialized and processed into input sequence 5. It is to be understood that element(s) 5-1, 5-2, . . . 5-M can be the tokens or can be the embedded representations thereof.

Prediction layer(s) 6 can predict one or more output elements 7-1, 7-2, . . . 7-N based on the input elements. Prediction layer(s) 6 can include one or more machine-learned model architectures, such as one or more layers of learned parameters that manipulate and transform the input(s) to extract higher-order meaning from, and relationships between, input element(s) 5-1, 5-2, . . . 5-M. In this manner, for instance, example prediction layer(s) 6 can predict new output element(s) in view of the context provided by input sequence 5.

Prediction layer(s) 6 can evaluate associations between portions of input sequence 5 and a particular output element. These associations can inform a prediction of the likelihood that a particular output follows the input context. For example, consider the textual snippet, “The carpenter's toolbox was small and heavy. It was full of ___.” Example prediction layer(s) 6 can identify that “It” refers back to “toolbox” by determining a relationship between the respective embeddings. Example prediction layer(s) 6 can also link “It” to the attributes of the toolbox, such as “small” and “heavy.” Based on these associations, prediction layer(s) 6 can, for instance, assign a higher probability to the word “nails” than to the word “sawdust.”

A transformer is an example architecture that can be used in prediction layer(s) 6. See, e.g., Vaswani et al., Attention Is All You Need, ARXIV:1706.03762v7 (Aug. 2, 2023). A transformer is an example of a machine-learned model architecture that uses an attention mechanism to compute associations between items within a context window. The context window can include a sequence that contains input sequence 5 and potentially one or more output element(s) 7-1, 7-2, . . . 7-N. A transformer block can include one or more attention layer(s) and one or more post-attention layer(s) (e.g., feedforward layer(s), such as a multi-layer perceptron).

Prediction layer(s) 6 can include other machine-learned model architectures in addition to or in lieu of transformer-based architectures. For example, recurrent neural networks (RNNs) and long short-term memory (LSTM) models can also be used, as well as convolutional neural networks (CNNs). In general, prediction layer(s) 6 can leverage various kinds of artificial neural networks that can understand or generate sequences of information.

Output sequence 7 can include or otherwise represent the same or different data types as input sequence 5. For instance, input sequence 5 can represent textual data, and output sequence 7 can represent textual data. Input sequence 5 can represent image, audio, or audiovisual data, and output sequence 7 can represent textual data (e.g., describing the image, audio, or audiovisual data). It is to be understood that prediction layer(s) 6, and any other interstitial model components of sequence processing model(s) 4, can be configured to receive a variety of data types in input sequence(s) 5 and output a variety of data types in output sequence(s) 7.

Output sequence 7 can have various relationships to input sequence 5. Output sequence 7 can be a continuation of input sequence 5. Output sequence 7 can be complementary to input sequence 5. Output sequence 7 can translate, transform, augment, or otherwise modify input sequence 5. Output sequence 7 can answer, evaluate, confirm, or otherwise respond to input sequence 5. Output sequence 7 can implement (or describe instructions for implementing) an instruction provided via input sequence 5.

Output sequence 7 can be generated autoregressively. For instance, for some applications, an output of one or more prediction layer(s) 6 can be passed through one or more output layers (e.g., softmax layer) to obtain a probability distribution over an output vocabulary (e.g., a textual or symbolic vocabulary) conditioned on a set of input elements in a context window. In this manner, for instance, output sequence 7 can be autoregressively generated by sampling a likely next output element, adding that element to the context window, and re-generating the probability distribution based on the updated context window, and sampling a likely next output element, and so forth.

Output sequence 7 can also be generated non-autoregressively. For instance, multiple output elements of output sequence 7 can be predicted together without explicit sequential conditioning on each other. See, e.g., Saharia et al., Non-Autoregressive Machine Translation with Latent Alignments, ARXIV:2004.07437v3 (Nov. 16, 2020).

Output sequence 7 can include one or multiple portions or elements. In an example content generation configuration, output sequence 7 can include multiple elements corresponding to multiple portions of a generated output sequence (e.g., a textual sentence, values of a discretized waveform, computer code, etc.). In an example classification configuration, output sequence 7 can include a single element associated with a classification output. For instance, an output “vocabulary” can include a set of classes into which an input sequence is to be classified. For instance, a vision transformer block can pass latent state information to a multilayer perceptron that outputs a likely class value associated with an input image.

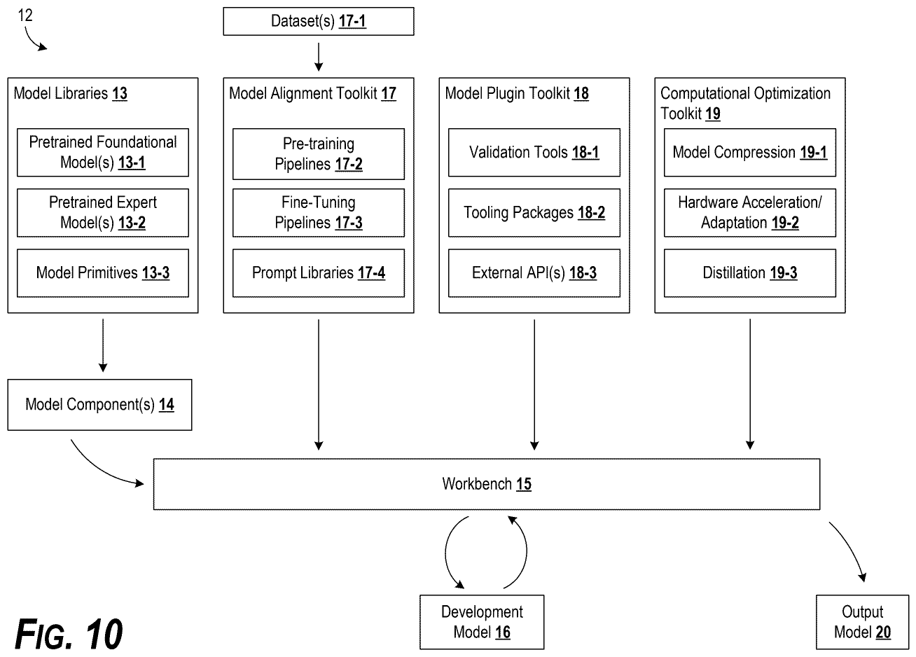

FIG. 9 is a block diagram of an example technique for populating an example input sequence 8. Input sequence 8 can include various functional elements that form part of the model infrastructure, such as an element 8-0 obtained from a task indicator 9 that signals to any model(s) that process input sequence 8 that a particular task is being performed (e.g., to help adapt a performance of the model(s) to that particular task). Input sequence 8 can include various data elements from different data modalities. For instance, an input modality 10-1 can include one modality of data. A data-to-sequence model 11-1 can process data from input modality 10-1 to project the data into a format compatible with input sequence 8 (e.g., one or more vectors dimensioned according to the dimensions of input sequence 8) to obtain elements 8-1, 8-2, 8-3. Another input modality 10-2 can include a different modality of data. A data-to-sequence model 11-2 can project data from input modality 10-2 into a format compatible with input sequence 8 to obtain elements 8-4, 8-5, 8-6. Another input modality 10-3 can include yet another different modality of data. A data-to-sequence model 11-3 can project data from input modality 10-3 into a format compatible with input sequence 8 to obtain elements 8-7, 8-8, 8-9.

Input sequence 8 can be the same as or different from input sequence 5. Input sequence 8 can be a multimodal input sequence that contains elements that represent data from different modalities using a common dimensional representation. For instance, an embedding space can have P dimensions. Input sequence 8 can be configured to contain a plurality of elements that have P dimensions. In this manner, for instance, example implementations can facilitate information extraction and reasoning across diverse data modalities by projecting data into elements in the same embedding space for comparison, combination, or other computations therebetween.

For example, elements 8-0, . . . 8-9 can indicate particular locations within a multidimensional embedding space. Some elements can map to a set of discrete locations in the embedding space. For instance, elements that correspond to discrete members of a predetermined vocabulary of tokens can map to discrete locations in the embedding space that are associated with those tokens. Other elements can be continuously distributed across the embedding space. For instance, some data types can be broken down into continuously defined portions (e.g., image patches) that can be described using continuously distributed locations within the embedding space.

In some implementations, the expressive power of the embedding space may not be limited to meanings associated with any particular set of tokens or other building blocks. For example, a continuous embedding space can encode a spectrum of high-order information. An individual piece of information (e.g., a token) can map to a particular point in that space: for instance, a token for the word “dog” can be projected to an embedded value that points to a particular location in the embedding space associated with canine-related information. Similarly, an image patch of an image of a dog on grass can also be projected into the embedding space. In some implementations, the projection of the image of the dog can be similar to the projection of the word “dog” while also having similarity to a projection of the word “grass,” while potentially being different from both. In some implementations, the projection of the image patch may not exactly align with any single projection of a single word. In some implementations, the projection of the image patch can align with a combination of the projections of the words “dog” and “grass.” In this manner, for instance, a high-order embedding space can encode information that can be independent of data modalities in which the information is expressed.

Task indicator 9 can include a model or model component configured to identify a task being performed and inject, into input sequence 8, an input value represented by element 8-0 that signals which task is being performed. For instance, the input value can be provided as a data type associated with an input modality and projected along with that input modality (e.g., the input value can be a textual task label that is embedded along with other textual data in the input; the input value can be a pixel-based representation of a task that is embedded along with other image data in the input; etc.). The input value can be provided as a data type that differs from or is at least independent from other input(s). For instance, the input value represented by element 8-0 can be learned within a continuous embedding space.

Input modalities 10-1, 10-2, and 10-3 can be associated with various different data types (e.g., as described above with respect to input(s) 2 and output(s) 3).

Data-to-sequence models 11-1, 11-2, and 11-3 can be the same or different from each other. Data-to-sequence models 11-1, 11-2, and 11-3 can be adapted to each respective input modality 10-1, 10-2, and 10-3. For example, a textual data-to-sequence model can subdivide a portion of input text and project the subdivisions into element(s) in input sequence 8 (e.g., elements 8-1, 8-2, 8-3, etc.). An image data-to-sequence model can subdivide an input image and project the subdivisions into element(s) in input sequence 8 (e.g., elements 8-4, 8-5, 8-6, etc.). An arbitrary data type data-to-sequence model can subdivide an input of that arbitrary data type and project the subdivisions into element(s) in input sequence 8 (e.g., elements 8-7, 8-8, 8-9, etc.).

Data-to-sequence models 11-1, 11-2, and 11-3 can form part of machine-learned sequence processing model(s) 4. Data-to-sequence models 11-1, 11-2, and 11-3 can be jointly trained with or trained independently from machine-learned sequence processing model(s) 4. Data-to-sequence models 11-1, 11-2, and 11-3 can be trained end-to-end with machine-learned sequence processing model(s) 4.

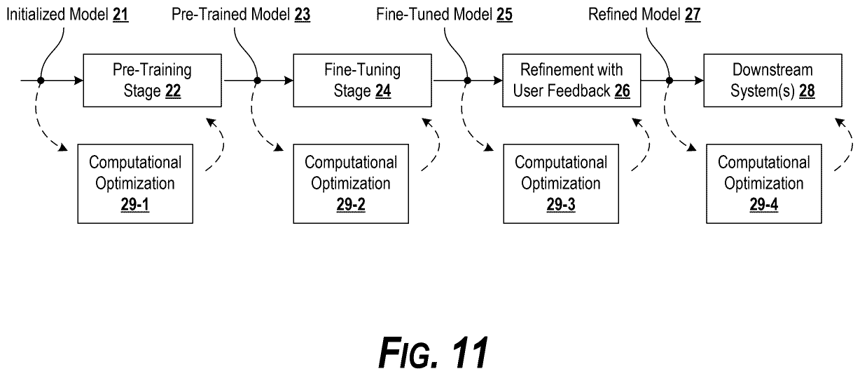

FIG. 10 is a block diagram of an example model development platform 12 that can facilitate creation, adaptation, and refinement of example machine-learned models (e.g., machine-learned model(s) 1, sequence processing model(s) 4, etc.). Model development platform 12 can provide a number of different toolkits that developer systems can employ in the development of new or adapted machine-learned models.

Model development platform 12 can provide one or more model libraries 13 containing building blocks for new models. Model libraries 13 can include one or more pre-trained foundational models 13-1, which can provide a backbone of processing power across various tasks. Model libraries 13 can include one or more pre-trained expert models 13-2, which can be focused on performance in particular domains of expertise. Model libraries 13 can include various model primitives 13-3, which can provide low-level architectures or components (optionally pre-trained), which can be assembled in various arrangements as desired. Model primitives 13-3 can include a library of pre-trained adapters or LoRA modules that can adapt a baseline foundational model to align its outputs with a desired performance profile, augment model capabilities (e.g., to adapt to a different input modality, etc.), and the like.

Model development platform 12 can receive selections of various model components 14. Model development platform 12 can pass selected model components 14 to a workbench 15 that combines selected model components 14 into a development model 16.

Workbench 15 can facilitate further refinement and adaptation of development model 16 by leveraging a number of different toolkits integrated with model development platform 12. For example, workbench 15 can facilitate alignment of the development model 16 with a desired performance profile on various tasks using a model alignment toolkit 17.

Model alignment toolkit 17 can provide a number of tools for causing development model 16 to generate outputs aligned with desired behavioral characteristics. Alignment can include increasing the accuracy, precision, recall, etc. of model outputs. Alignment can include enforcing output styles, schema, or other preferential characteristics of model outputs. Alignment can be general or domain-specific. For instance, a pre-trained foundational model 13-1 can begin with an initial level of performance across multiple domains. Alignment of the pre-trained foundational model 13-1 can include improving a performance in a particular domain of information or tasks (e.g., even at the expense of performance in another domain of information or tasks).

Model alignment toolkit 17 can integrate one or more dataset(s) 17-1 for aligning development model 16. Curated dataset(s) 17-1 can include labeled or unlabeled training data. Dataset(s) 17-1 can be obtained from public domain datasets. Dataset(s) 17-1 can be obtained from private datasets associated with one or more developer system(s) for the alignment of bespoke machine-learned model(s) customized for private use-cases.

Pre-training pipelines 17-2 can include a machine-learned model training workflow configured to update development model 16 over large-scale, potentially noisy datasets. For example, pre-training can leverage unsupervised learning techniques (e.g., de-noising, etc.) to process large numbers of training instances to update model parameters from an initialized state and achieve a desired baseline performance. Pre-training pipelines 17-2 can leverage unlabeled datasets in dataset(s) 17-1 to perform pre-training. Workbench 15 can implement a pre-training pipeline 17-2 to pre-train development model 16.

Fine-tuning pipelines 17-3 can include a machine-learned model training workflow configured to refine the model parameters of development model 16 with higher-quality data. Fine-tuning pipelines 17-3 can update development model 16 by conducting supervised training with labeled dataset(s) in dataset(s) 17-1. Fine-tuning pipelines 17-3 can update development model 16 by conducting reinforcement learning using reward signals from user feedback signals. Workbench 15 can implement a fine-tuning pipeline 17-3 to fine-tune development model 16.

Prompt libraries 17-4 can include sets of inputs configured to induce behavior aligned with desired performance criteria. Prompt libraries 17-4 can include few-shot prompts (e.g., inputs providing examples of desired model outputs for prepending to a desired runtime query), chain-of-thought prompts (e.g., inputs providing step-by-step reasoning within the exemplars to facilitate thorough reasoning by the model), and the like.

Example prompts can be retrieved from an available repository of prompt libraries 17-4. Example prompts can be contributed by one or more developer systems using workbench 15.

In some implementations, pre-trained or fine-tuned models can achieve satisfactory performance without exemplars in the inputs. For instance, zero-shot prompts can include inputs that lack exemplars. Zero-shot prompts can be within a domain within a training dataset or outside of the training domain(s).

Prompt libraries 17-4 can include one or more prompt engineering tools. Prompt engineering tools can provide workflows for retrieving or learning optimized prompt values. Prompt engineering tools can facilitate directly learning prompt values (e.g., input element values) based on one or more training iterations. Workbench 15 can implement prompt engineering tools in development model 16.

Prompt libraries 17-4 can include pipelines for prompt generation. For example, inputs can be generated using development model 16 itself or other machine-learned models. In this manner, for instance, a first model can process information about a task and output an input for a second model to process in order to perform a step of the task. The second model can be the same as or different from the first model. Workbench 15 can implement prompt generation pipelines in development model 16.

Prompt libraries 17-4 can include pipelines for context injection. For instance, a performance of development model 16 on a particular task can improve if provided with additional context for performing the task. Prompt libraries 17-4 can include software components configured to identify desired context, retrieve the context from an external source (e.g., a database, a sensor, etc.), and add the context to the input prompt. Workbench 15 can implement context injection pipelines in development model 16.

Although various training examples described herein with respect to model development platform 12 refer to “pre-training” and “fine-tuning,” it is to be understood that model alignment toolkit 17 can generally support a wide variety of training techniques adapted for training a wide variety of machine-learned models. Example training techniques can correspond to the example training method 600 described above.

Model development platform 12 can include a model plugin toolkit 18. Model plugin toolkit 18 can include a variety of tools configured for augmenting the functionality of a machine-learned model by integrating the machine-learned model with other systems, devices, and software components. For instance, a machine-learned model can use tools to increase performance quality where appropriate. For instance, deterministic tasks can be offloaded to dedicated tools in lieu of probabilistically performing the task with an increased risk of error. For instance, instead of autoregressively predicting the solution to a system of equations, a machine-learned model can recognize a tool to call for obtaining the solution and pass the system of equations to the appropriate tool. The tool can be a traditional system of equations solver that can operate deterministically to resolve the system of equations. The output of the tool can be returned in response to the original query. In this manner, tool use can allow some example models to focus on the strengths of machine-learned models—e.g., understanding an intent in an unstructured request for a task—while augmenting the performance of the model by offloading certain tasks to a more focused tool for rote application of deterministic algorithms to a well-defined problem.

Model plugin toolkit 18 can include validation tools 18-1. Validation tools 18-1 can include tools that can parse and confirm output(s) of a machine-learned model. Validation tools 18-1 can include engineered heuristics that establish certain thresholds applied to model outputs. For example, validation tools 18-1 can ground the outputs of machine-learned models to structured data sources (e.g., to mitigate “hallucinations”).

Model plugin toolkit 18 can include tooling packages 18-2 for implementing one or more tools that can include scripts or other executable code that can be executed alongside development model 16. Tooling packages 18-2 can include one or more inputs configured to cause machine-learned model(s) to implement the tools (e.g., few-shot prompts that induce a model to output tool calls in the proper syntax, etc.). Tooling packages 18-2 can include, for instance, fine-tuning training data for training a model to use a tool.

Model plugin toolkit 18 can include interfaces for calling external application programming interfaces (APIs) 18-3. For instance, in addition to or in lieu of implementing tool calls or tool code directly with development model 16, development model 16 can be aligned to output instructions that initiate API calls to send or obtain data via external systems.

Model plugin toolkit 18 can integrate with prompt libraries 17-4 to build a catalog of available tools for use with development model 16. For instance, a model can receive, in an input, a catalog of available tools, and the model can generate an output that selects a tool from the available tools and initiates a tool call for using the tool.

Model development platform 12 can include a computational optimization toolkit 19 for optimizing a computational performance of development model 16. For instance, tools for model compression 19-1 can allow development model 16 to be reduced in size while maintaining a desired level of performance. For instance, model compression 19-1 can include quantization workflows, weight pruning and sparsification techniques, etc. Tools for hardware acceleration 19-2 can facilitate the configuration of the model storage and execution formats to operate optimally on different hardware resources. For instance, hardware acceleration 19-2 can include tools for optimally sharding models for distributed processing over multiple processing units for increased bandwidth, lower unified memory requirements, etc. Tools for distillation 19-3 can provide for the training of lighter-weight models based on the knowledge encoded in development model 16. For instance, development model 16 can be a highly performant, large machine-learned model optimized using model development platform 12. To obtain a lightweight model for running in resource-constrained environments, a smaller model can be a “student model” that learns to imitate development model 16 as a “teacher model.” In this manner, for instance, the investment in learning the parameters and configurations of development model 16 can be efficiently transferred to a smaller model for more efficient inference.

Workbench 15 can implement one, multiple, or none of the toolkits implemented in model development platform 12. Workbench 15 can output an output model 20 based on development model 16. Output model 20 can be a deployment version of development model 16. Output model 20 can be a development or training checkpoint of development model 16. Output model 20 can be a distilled, compressed, or otherwise optimized version of development model 16.

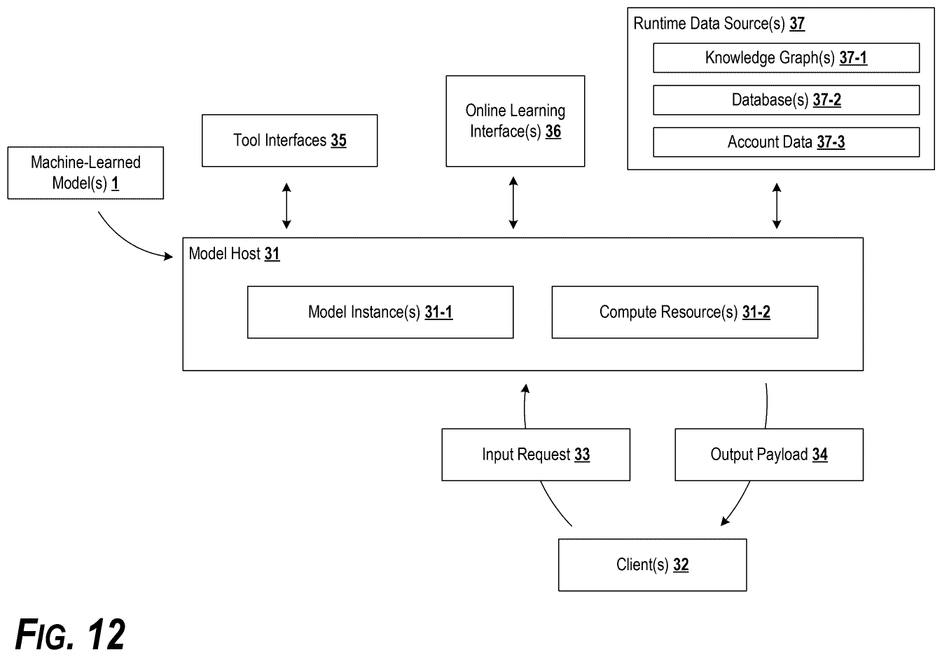

FIG. 11 is a block diagram of an example training flow for training a machine-learned development model 16. One or more portion(s) of the example training flow can be implemented by a computing system that includes one or more computing devices such as, for example, computing systems described with reference to the other figures. Each respective portion of the example training flow can be performed by any (or any combination) of one or more computing devices. Moreover, one or more portion(s) of the example training flow can be implemented on the hardware components of the device(s) described herein, for example, to train one or more systems or models. FIG. 11 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 11 is described with reference to elements/terms described with respect to other systems and figures for exemplary illustrated purposes and is not meant to be limiting. One or more portions of the example training flow can be performed additionally, or alternatively, by other systems.

Initially, development model 16 can persist in an initial state as an initialized model 21. Development model 16 can be initialized with weight values. Initial weight values can be random or based on an initialization schema. Initial weight values can be based on prior pre-training for the same or for a different model.

Initialized model 21 can undergo pre-training in a pre-training stage 22. Pre-training stage 22 can be implemented using one or more pre-training pipelines 17-2 over data from dataset(s) 17-1. Pre-training can be omitted, for example, if initialized model 21 is already pre-trained (e.g., development model 16 contains, is, or is based on a pre-trained foundational model or an expert model).

Pre-trained model 23 can then be a new version of development model 16, which can persist as development model 16 or as a new development model. Pre-trained model 23 can be the initial state if development model 16 was already pre-trained. Pre-trained model 23 can undergo fine-tuning in a fine-tuning stage 24. Fine-tuning stage 24 can be implemented using one or more fine-tuning pipelines 17-3 over data from dataset(s) 17-1. Fine-tuning can be omitted, for example, if a pre-trained model has satisfactory performance, if the model was already fine-tuned, or if other tuning approaches are preferred.

Fine-tuned model 25 can then be a new version of development model 16, which can persist as development model 16 or as a new development model. Fine-tuned model 25 can be the initial state if development model 16 was already fine-tuned. Fine-tuned model 25 can undergo refinement with user feedback 26. For instance, refinement with user feedback 26 can include reinforcement learning, optionally based on human feedback from human users of fine-tuned model 25. As reinforcement learning can be a form of fine-tuning, it is to be understood that fine-tuning stage 24 can subsume the stage for refining with user feedback 26. Refinement with user feedback 26 can produce a refined model 27. Refined model 27 can be output to downstream system(s) 28 for deployment or further development.

In some implementations, computational optimization operations can be applied before, during, or after each stage. For instance, initialized model 21 can undergo computational optimization 29-1 (e.g., using computational optimization toolkit 19) before pre-training stage 22. Pre-trained model 23 can undergo computational optimization 29-2 (e.g., using computational optimization toolkit 19) before fine-tuning stage 24. Fine-tuned model 25 can undergo computational optimization 29-3 (e.g., using computational optimization toolkit 19) before refinement with user feedback 26. Refined model 27 can undergo computational optimization 29-4 (e.g., using computational optimization toolkit 19) before output to downstream system(s) 28. Computational optimization(s) 29-1,. 29-4 can all be the same, all be different, or include at least some different optimization techniques.

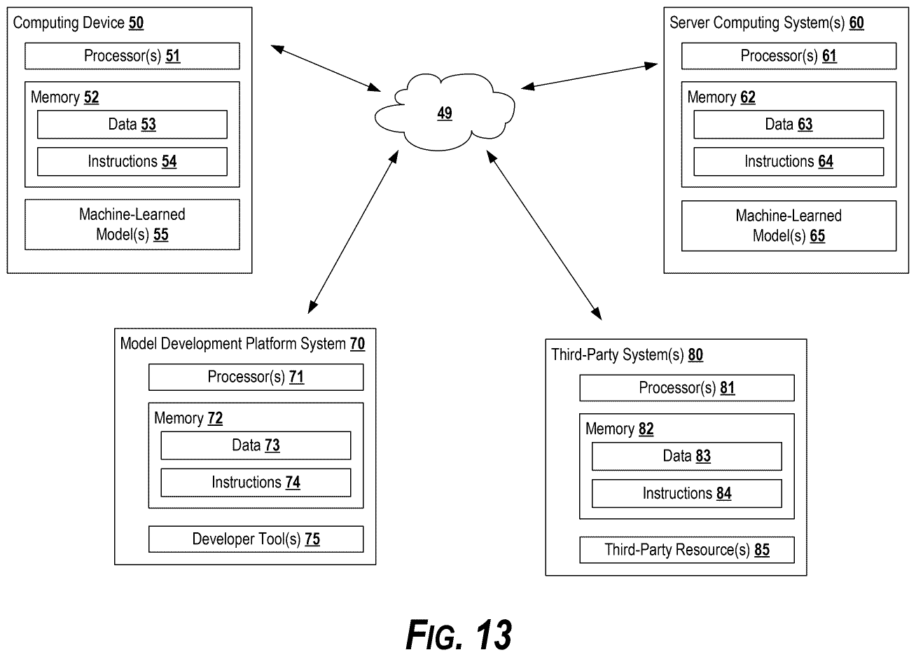

FIG. 12 is a block diagram of an inference system for operating one or more machine-learned model(s) 1 to perform inference (e.g., for training, for deployment, etc.). A model host 31 can receive machine-learned model(s) 1. Model host 31 can host one or more model instance(s) 31-1, which can be one or multiple instances of one or multiple models. Model host 31 can host model instance(s) 31-1 using available compute resources 31-2 associated with model host 31.

Model host 31 can perform inference on behalf of one or more client(s) 32. Client(s) 32 can transmit an input request 33 to model host 31. Using input request 33, model host 31 can obtain input(s) 2 for input to machine-learned model(s) 1. Machine-learned model(s) 1 can process input(s) 2 to generate output(s) 3. Using output(s) 3, model host 31 can return an output payload 34 for responding to input request 33 from client(s) 32. Output payload 34 can include or be based on output(s) 3.

Model host 31 can leverage various other resources and tools to augment the inference task. For instance, model host 31 can communicate with tool interfaces 35 to facilitate tool use by model instance(s) 31-1. Tool interfaces 35 can include local or remote APIs. Tool interfaces 35 can include integrated scripts or other software functionality. Model host 31 can engage online learning interface(s) 36 to facilitate ongoing improvements to machine-learned model(s) 1. For instance, online learning interface(s) 36 can be used within reinforcement learning loops to retrieve user feedback on inferences served by model host 31. Model host 31 can access runtime data source(s) 37 for augmenting input(s) 2 with additional contextual information. For instance, runtime data source(s) 37 can include a knowledge graph 37-1 that facilitates structured information retrieval for information associated with input request(s) 33 (e.g., a search engine service). Runtime data source(s) 37 can include public or private, external or local database(s) 37-2 that can store information associated with input request(s) 33 for augmenting input(s) 2. Runtime data source(s) 37 can include account data 37-3 which can be retrieved in association with a user account corresponding to a client 32 for customizing the behavior of model host 31 accordingly.

Model host 31 can be implemented by one or multiple computing devices or systems. Client(s) 32 can be implemented by one or multiple computing devices or systems, which can include computing devices or systems shared with model host 31.

For example, model host 31 can operate on a server system that provides a machine-learning service to client device(s) that operate client(s) 32 (e.g., over a local or wide-area network). Client device(s) can be end-user devices used by individuals. Client device(s) can be server systems that operate client(s) 32 to provide various functionality as a service to downstream end-user devices.

In some implementations, model host 31 can operate on the same device or system as client(s) 32. Model host 31 can be a machine-learning service that runs on-device to provide machine-learning functionality to one or multiple applications operating on a client device, which can include an application implementing client(s) 32. Model host 31 can be a part of the same application as client(s) 32. For instance, model host 31 can be a subroutine or method implemented by one part of an application, and client(s) 32 can be another subroutine or method that engages model host 31 to perform inference functions within the application. It is to be understood that model host 31 and client(s) 32 can have various different configurations.

Model instance(s) 31-1 can include one or more machine-learned models that are available for performing inference. Model instance(s) 31-1 can include weights or other model components that are stored in persistent storage, temporarily cached, or loaded into high-speed memory. Model instance(s) 31-1 can include multiple instance(s) of the same model (e.g., for parallel execution of more requests on the same model). Model instance(s) 31-1 can include instance(s) of different model(s). Model instance(s) 31-1 can include cached intermediate states of active or inactive model(s) used to accelerate inference of those models. For instance, an inference session with a particular model may generate significant amounts of computational results that can be re-used for future inference runs (e.g., using a KV cache for transformer-based models). These computational results can be saved in association with that inference session so that session can be executed more efficiently when resumed.

Compute resource(s) 31-2 can include one or more processors (central processing units, graphical processing units, tensor processing units, machine-learning accelerators, etc.) connected to one or more memory devices. Compute resource(s) 31-2 can include a dynamic pool of available resources shared with other processes. Compute resource(s) 31-2 can include memory devices large enough to fit an entire model instance in a single memory instance. Compute resource(s) 31-2 can also shard model instance(s) across multiple memory devices (e.g., using data parallelization or tensor parallelization, etc.). This can be done to increase parallelization or to execute a large model using multiple memory devices which individually might not be able to fit the entire model into memory.

Input request 33 can include data for input(s) 2. Model host 31 can process input request 33 to obtain input(s) 2. Input(s) 2 can be obtained directly from input request 33 or can be retrieved using input request 33. Input request 33 can be submitted to model host 31 via an API.

Model host 31 can perform inference over batches of input requests 33 in parallel. For instance, a model instance 31-1 can be configured with an input structure that has a batch dimension. Separate input(s) 2 can be distributed across the batch dimension (e.g., rows of an array). The separate input(s) 2 can include completely different contexts. The separate input(s) 2 can be multiple inference steps of the same task. The separate input(s) 2 can be staggered in an input structure, such that any given inference cycle can be operating on different portions of the respective input(s) 2. In this manner, for instance, model host 31 can perform inference on the batch in parallel, such that output(s) 3 can also contain the batch dimension and return the inference results for the batched input(s) 2 in parallel. In this manner, for instance, batches of input request(s) 33 can be processed in parallel for higher throughput of output payload(s) 34.

Output payload 34 can include or be based on output(s) 3 from machine-learned model(s) 1. Model host 31 can process output(s) 3 to obtain output payload 34. This can include chaining multiple rounds of inference (e.g., iteratively, recursively, across the same model(s) or different model(s)) to arrive at a final output for a task to be returned in output payload 34. Output payload 34 can be transmitted to client(s) 32 via an API.

Online learning interface(s) 36 can facilitate reinforcement learning of machine-learned model(s) 1. Online learning interface(s) 36 can facilitate reinforcement learning with human feedback (RLHF). Online learning interface(s) 36 can facilitate federated learning of machine-learned model(s) 1.

Model host 31 can access a library of pre-trained adapters or LoRA modules that can adapt a baseline model to align its outputs with a desired performance profile, augment model capabilities (e.g., to adapt to a different input modality, etc.), and the like. For instance, model host 31 can receive an input request to load a customized model, and model host 31 can retrieve one or more components to adapt a baseline model to the custom profile. Model host 31 can determine that a particular functionality is needed for a particular task (e.g., based on an output of a model that preprocesses an input) and retrieve a pre-trained component accordingly.

Model host 31 can execute machine-learned model(s) 1 to perform inference for various tasks using various types of data. For example, various different input(s) 2 and output(s) 3 can be used for various different tasks. In some implementations, input(s) 2 can be or otherwise represent image data. Machine-learned model(s) 1 can process the image data to generate an output. As an example, machine-learned model(s) 1 can process the image data to generate an image recognition output (e.g., a recognition of the image data, a latent embedding of the image data, an encoded representation of the image data, a hash of the image data, etc.). As another example, machine-learned model(s) 1 can process the image data to generate an image segmentation output. As another example, machine-learned model(s) 1 can process the image data to generate an image classification output. As another example, machine-learned model(s) 1 can process the image data to generate an image data modification output (e.g., an alteration of the image data, etc.). As another example, machine-learned model(s) 1 can process the image data to generate an encoded image data output (e.g., an encoded and/or compressed representation of the image data, etc.). As another example, machine-learned model(s) 1 can process the image data to generate an upscaled image data output. As another example, machine-learned model(s) 1 can process the image data to generate a prediction output.

In some implementations, the task is a computer vision task. In some cases, input(s) 2 includes pixel data for one or more images and the task is an image processing task. For example, the image processing task can be image classification, where the output is a set of scores, each score corresponding to a different object class and representing the likelihood that the one or more images depict an object belonging to the object class. The image processing task may be object detection, where the image processing output identifies one or more regions in the one or more images and, for each region, a likelihood that region depicts an object of interest. As another example, the image processing task can be image segmentation, where the image processing output defines, for each pixel in the one or more images, a respective likelihood for each category in a predetermined set of categories. For example, the set of categories can be foreground and background. As another example, the set of categories can be object classes. As another example, the image processing task can be depth estimation, where the image processing output defines, for each pixel in the one or more images, a respective depth value. As another example, the image processing task can be motion estimation, where the network input includes multiple images, and the image processing output defines, for each pixel of one of the input images, a motion of the scene depicted at the pixel between the images in the network input.

In some implementations, input(s) 2 can be or otherwise represent natural language data. Machine-learned model(s) 1 can process the natural language data to generate an output. As an example, machine-learned model(s) 1 can process the natural language data to generate a language encoding output. As another example, machine-learned model(s) 1 can process the natural language data to generate a latent text embedding output. As another example, machine-learned model(s) 1 can process the natural language data to generate a translation output. As another example, machine-learned model(s) 1 can process the natural language data to generate a classification output. As another example, machine-learned model(s) 1 can process the natural language data to generate a textual segmentation output. As another example, machine-learned model(s) 1 can process the natural language data to generate a semantic intent output. As another example, machine-learned model(s) 1 can process the natural language data to generate an upscaled text or natural language output (e.g., text or natural language data that is higher quality than the input text or natural language, etc.). As another example, machine-learned model(s) 1 can process the natural language data to generate a prediction output (e.g., one or more predicted next portions of natural language content).

In some implementations, input(s) 2 can be or otherwise represent speech data (e.g., data describing spoken natural language, such as audio data, textual data, etc.). Machine-learned model(s) 1 can process the speech data to generate an output. As an example, machine-learned model(s) 1 can process the speech data to generate a speech recognition output. As another example, machine-learned model(s) 1 can process the speech data to generate a speech translation output. As another example, machine-learned model(s) 1 can process the speech data to generate a latent embedding output. As another example, machine-learned model(s) 1 can process the speech data to generate an encoded speech output (e.g., an encoded and/or compressed representation of the speech data, etc.). As another example, machine-learned model(s) 1 can process the speech data to generate an upscaled speech output (e.g., speech data that is higher quality than the input speech data, etc.). As another example, machine-learned model(s) 1 can process the speech data to generate a textual representation output (e.g., a textual representation of the input speech data, etc.). As another example, machine-learned model(s) 1 can process the speech data to generate a prediction output.

In some implementations, input(s) 2 can be or otherwise represent latent encoding data (e.g., a latent space representation of an input, etc.). Machine-learned model(s) 1 can process the latent encoding data to generate an output. As an example, machine-learned model(s) 1 can process the latent encoding data to generate a recognition output. As another example, machine-learned model(s) 1 can process the latent encoding data to generate a reconstruction output. As another example, machine-learned model(s) 1 can process the latent encoding data to generate a search output. As another example, machine-learned model(s) 1 can process the latent encoding data to generate a reclustering output. As another example, machine-learned model(s) 1 can process the latent encoding data to generate a prediction output.

In some implementations, input(s) 2 can be or otherwise represent statistical data. Statistical data can be, represent, or otherwise include data computed and/or calculated from some other data source. Machine-learned model(s) 1 can process the statistical data to generate an output. As an example, machine-learned model(s) 1 can process the statistical data to generate a recognition output. As another example, machine-learned model(s) 1 can process the statistical data to generate a prediction output. As another example, machine-learned model(s) 1 can process the statistical data to generate a classification output. As another example, machine-learned model(s) 1 can process the statistical data to generate a segmentation output. As another example, machine-learned model(s) 1 can process the statistical data to generate a visualization output. As another example, machine-learned model(s) 1 can process the statistical data to generate a diagnostic output.

In some implementations, input(s) 2 can be or otherwise represent sensor data. Machine-learned model(s) 1 can process the sensor data to generate an output. As an example, machine-learned model(s) 1 can process the sensor data to generate a recognition output. As another example, machine-learned model(s) 1 can process the sensor data to generate a prediction output. As another example, machine-learned model(s) 1 can process the sensor data to generate a classification output. As another example, machine-learned model(s) 1 can process the sensor data to generate a segmentation output. As another example, machine-learned model(s) 1 can process the sensor data to generate a visualization output. As another example, machine-learned model(s) 1 can process the sensor data to generate a diagnostic output. As another example, machine-learned model(s) 1 can process the sensor data to generate a detection output.

In some implementations, machine-learned model(s) 1 can be configured to perform a task that includes encoding input data for reliable and/or efficient transmission or storage (and/or corresponding decoding). For example, the task may be an audio compression task. The input may include audio data and the output may include compressed audio data. In another example, the input includes visual data (e.g. one or more images or videos), the output includes compressed visual data, and the task is a visual data compression task. In another example, the task may include generating an embedding for input data (e.g. input audio or visual data). In some cases, the input includes audio data representing a spoken utterance and the task is a speech recognition task. The output may include a text output which is mapped to the spoken utterance. In some cases, the task includes encrypting or decrypting input data. In some cases, the task includes a microprocessor performance task, such as branch prediction or memory address translation.

In some implementations, the task is a generative task, and machine-learned model(s) 1 can be configured to output content generated in view of input(s) 2. For instance, input(s) 2 can be or otherwise represent data of one or more modalities that encodes context for generating additional content.

In some implementations, the task can be a text completion task. Machine-learned model(s) 1 can be configured to process input(s) 2 that represent textual data and to generate output(s) 3 that represent additional textual data that completes a textual sequence that includes input(s) 2. For instance, machine-learned model(s) 1 can be configured to generate output(s) 3 to complete a sentence, paragraph, or portion of text that follows from a portion of text represented by input(s) 2.

In some implementations, the task can be an instruction-following task. Machine-learned model(s) 1 can be configured to process input(s) 2 that represent instructions to perform a function and to generate output(s) 3 that advance a goal of satisfying the instruction function (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the instructions (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the instructions (e.g., natural language responses, programming language responses, machine language responses, etc.). One or more output(s) 3 can be iteratively or recursively generated to sequentially process and accomplish steps toward accomplishing the requested functionality. For instance, an initial output can be executed by an external system or be processed by machine-learned model(s) 1 to complete an initial step of performing a function. Multiple steps can be performed, with a final output being obtained that is responsive to the initial instructions.

In some implementations, the task can be a question answering task. Machine-learned model(s) 1 can be configured to process input(s) 2 that represent a question to answer and to generate output(s) 3 that advance a goal of returning an answer to the question (e.g., at least a step of a multi-step procedure to perform the function). Output(s) 3 can represent data of the same or of a different modality as input(s) 2. For instance, input(s) 2 can represent textual data (e.g., natural language instructions for a task to be performed) and machine-learned model(s) 1 can process input(s) 2 to generate output(s) 3 that represent textual data responsive to the question (e.g., natural language responses, programming language responses, machine language responses, etc.). Input(s) 2 can represent image data (e.g., image-based instructions for a task to be performed, optionally accompanied by textual instructions) and machine-learned model(s) 1 can process input(s) 2 to generate output(s) 3 that represent textual data responsive to the question (e.g., natural language responses, programming language responses, machine language responses, etc.). One or more output(s) 3 can be iteratively or recursively generated to sequentially process and accomplish steps toward answering the question. For instance, an initial output can be executed by an external system or be processed by machine-learned model(s) 1 to complete an initial step of obtaining an answer to the question (e.g., querying a database, performing a computation, executing a script, etc.). Multiple steps can be performed, with a final output being obtained that is responsive to the question.

In some implementations, the task can be an image generation task. Machine-learned model(s) 1 can be configured to process input(s) 2 that represent context regarding a desired portion of image content. The context can include text data, image data, audio data, etc. Machine-learned model(s) 1 can be configured to generate output(s) 3 that represent image data that depicts imagery related to the context. For instance, machine-learned model(s) 1 can be configured to generate pixel data of an image. Values for channel(s) associated with the pixels in the pixel data can be selected based on the context (e.g., based on a probability determined based on the context).

In some implementations, the task can be an audio generation task. Machine-learned model(s) 1 can be configured to process input(s) 2 that represent context regarding a desired portion of audio content. The context can include text data, image data, audio data, etc. Machine-learned model(s) 1 can be configured to generate output(s) 3 that represent audio data related to the context. For instance, machine-learned model(s) 1 can be configured to generate waveform data in the form of an image (e.g., a spectrogram). Values for channel(s) associated with pixels of the image can be selected based on the context. Machine-learned model(s) 1 can be configured to generate waveform data in the form of a sequence of discrete samples of a continuous waveform. Values of the sequence can be selected based on the context (e.g., based on a probability determined based on the context).

In some implementations, the task can be a data generation task. Machine-learned model(s) 1 can be configured to process input(s) 2 that represent context regarding a desired portion of data (e.g., data from various data domains, such as sensor data, image data, multimodal data, statistical data, etc.). The desired data can be, for instance, synthetic data for training other machine-learned models. The context can include arbitrary data type(s). Machine-learned model(s) 1 can be configured to generate output(s) 3 that represent data that aligns with the desired data. For instance, machine-learned model(s) 1 can be configured to generate data values for populating a dataset. Values for the data object(s) can be selected based on the context (e.g., based on a probability determined based on the context).

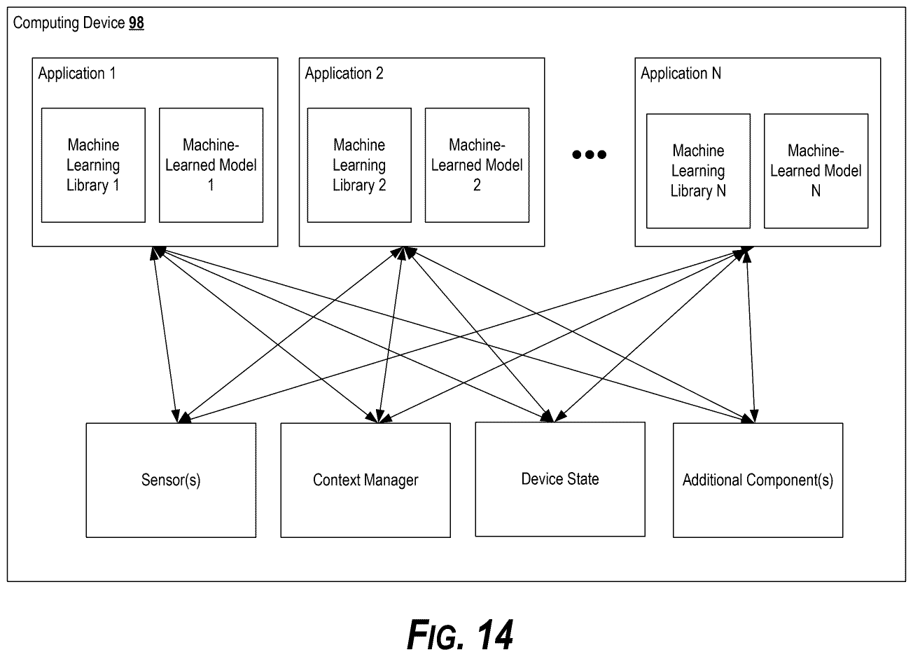

FIG. 13 is a block diagram of an example networked computing system that can perform aspects of example implementations of the present disclosure. The system can include a number of computing devices and systems that are communicatively coupled over a network 49. An example computing device 50 is described to provide an example of a computing device that can perform any aspect of the present disclosure (e.g., implementing model host 31, client(s) 32, or both). An example server computing system 60 is described as an example of a server computing system that can perform any aspect of the present disclosure (e.g., implementing model host 31, client(s) 32, or both). Computing device 50 and server computing system(s) 60 can cooperatively interact (e.g., over network 49) to perform any aspect of the present disclosure (e.g., implementing model host 31, client(s) 32, or both). Model development platform system 70 is an example system that can host or serve model development platform(s) 12 for development of machine-learned models. Third-party system(s) 80 are example system(s) with which any of computing device 50, server computing system(s) 60, or model development platform system(s) 70 can interact in the performance of various aspects of the present disclosure (e.g., engaging third-party tools, accessing third-party databases or other resources, etc.).

Network 49 can be any type of communications network, such as a local area network (e.g., intranet), wide area network (e.g., Internet), or some combination thereof and can include any number of wired or wireless links. In general, communication over network 49 can be carried via any type of wired or wireless connection, using a wide variety of communication protocols (e.g., TCP/IP, HTTP, SMTP, FTP), encodings or formats (e.g., HTML, XML), or protection schemes (e.g., VPN, secure HTTP, SSL). Network 49 can also be implemented via a system bus. For instance, one or more devices or systems of FIG. 13 can be co-located with, contained by, or otherwise integrated into one or more other devices or systems.

Computing device 50 can be any type of computing device, such as, for example, a personal computing device (e.g., laptop or desktop), a mobile computing device (e.g., smartphone or tablet), a gaming console or controller, a wearable computing device, an embedded computing device, a server computing device, a virtual machine operating on a host device, or any other type of computing device. Computing device 50 can be a client computing device. Computing device 50 can be an end-user computing device. Computing device 50 can be a computing device of a service provider that provides a service to an end user (who may use another computing device to interact with computing device 50).

Computing device 50 can include one or more processors 51 and a memory 52. Processor(s) 51 can be any suitable processing device (e.g., a processor core, a microprocessor, an ASIC, an FPGA, a controller, a microcontroller, etc.) and can be one processor or a plurality of processors that are operatively connected. Memory 52 can include one or more non-transitory computer-readable storage media, such as HBM, RAM, ROM, EEPROM, EPROM, flash memory devices, magnetic disks, etc., and combinations thereof. Memory 52 can store data 53 and instructions 54 which can be executed by processor(s) 51 to cause computing device 50 to perform operations. The operations can implement any one or multiple features described herein. The operations can implement example methods and techniques described herein.

Computing device 50 can also include one or more input components that receive user input. For example, a user input component can be a touch-sensitive component (e.g., a touch-sensitive display screen or a touch pad) that is sensitive to the touch of a user input object (e.g., a finger or a stylus). The touch-sensitive component can serve to implement a virtual keyboard. Other example user input components include a microphone, camera, LIDAR, a physical keyboard or other buttons, or other means by which a user can provide user input.

Computing device 50 can store or include one or more machine-learned models 55. Machine-learned models 55 can include one or more machine-learned model(s) 1, such as a sequence processing model 4. Machine-learned models 55 can include one or multiple model instance(s) 31-1. Machine-learned model(s) 55 can be received from server computing system(s) 60, model development platform system 70, third party system(s) 80 (e.g., an application distribution platform), or developed locally on computing device 50. Machine-learned model(s) 55 can be loaded into memory 52 and used or otherwise implemented by processor(s) 51. Computing device 50 can implement multiple parallel instances of machine-learned model(s) 55.

Server computing system(s) 60 can include one or more processors 61 and a memory 62. Processor(s) 61 can be any suitable processing device (e.g., a processor core, a microprocessor, an ASIC, an FPGA, a controller, a microcontroller, etc.) and can be one processor or a plurality of processors that are operatively connected. Memory 62 can include one or more non-transitory computer-readable storage media, such as HBM, RAM, ROM, EEPROM, EPROM, flash memory devices, magnetic disks, etc., and combinations thereof. Memory 62 can store data 63 and instructions 64 which can be executed by processor(s) 61 to cause server computing system(s) 60 to perform operations. The operations can implement any one or multiple features described herein. The operations can implement example methods and techniques described herein.

In some implementations, server computing system 60 includes or is otherwise implemented by one or multiple server computing devices. In instances in which server computing system 60 includes multiple server computing devices, such server computing devices can operate according to sequential computing architectures, parallel computing architectures, or some combination thereof.

Server computing system 60 can store or otherwise include one or more machine-learned models 65. Machine-learned model(s) 65 can be the same as or different from machine-learned model(s) 55. Machine-learned models 65 can include one or more machine-learned model(s) 1, such as a sequence processing model 4. Machine-learned models 65 can include one or multiple model instance(s) 31-1. Machine-learned model(s) 65 can be received from computing device 50, model development platform system 70, third party system(s) 80, or developed locally on server computing system(s) 60. Machine-learned model(s) 65 can be loaded into memory 62 and used or otherwise implemented by processor(s) 61. Server computing system(s) 60 can implement multiple parallel instances of machine-learned model(s) 65.

In an example configuration, machine-learned models 65 can be included in or otherwise stored and implemented by server computing system 60 to establish a client-server relationship with computing device 50 for serving model inferences. For instance, server computing system(s) 60 can implement model host 31 on behalf of client(s) 32 on computing device 50. For instance, machine-learned models 65 can be implemented by server computing system 60 as a portion of a web service (e.g., remote machine-learned model hosting service, such as an online interface for performing machine-learned model operations over a network on server computing system(s) 60). For instance, server computing system(s) 60 can communicate with computing device 50 over a local intranet or internet connection. For instance, computing device 50 can be a workstation or endpoint in communication with server computing system(s) 60, with implementation of machine-learned models 65 being managed by server computing system(s) 60 to remotely perform inference (e.g., for runtime or training operations), with output(s) returned (e.g., cast, streamed, etc.) to computing device 50. Machine-learned models 65 can work cooperatively or interoperatively with machine-learned models 55 on computing device 50 to perform various tasks.

Model development platform system(s) 70 can include one or more processors 71 and a memory 72. Processor(s) 71 can be any suitable processing device (e.g., a processor core, a microprocessor, an ASIC, an FPGA, a controller, a microcontroller, etc.) and can be one processor or a plurality of processors that are operatively connected. Memory 72 can include one or more non-transitory computer-readable storage media, such as HBM, RAM, ROM, EEPROM, EPROM, flash memory devices, magnetic disks, etc., and combinations thereof. Memory 72 can store data 73 and instructions 74 which can be executed by processor(s) 71 to cause model development platform system(s) 70 to perform operations. The operations can implement any one or multiple features described herein. The operations can implement example methods and techniques described herein. Example operations include the functionality described herein with respect to model development platform 12. This and other functionality can be implemented by developer tool(s) 75.

Third-party system(s) 80 can include one or more processors 81 and a memory 82. Processor(s) 81 can be any suitable processing device (e.g., a processor core, a microprocessor, an ASIC, an FPGA, a controller, a microcontroller, etc.) and can be one processor or a plurality of processors that are operatively connected. Memory 82 can include one or more non-transitory computer-readable storage media, such as HBM, RAM, ROM, EEPROM, EPROM, flash memory devices, magnetic disks, etc., and combinations thereof. Memory 82 can store data 83 and instructions 84 which can be executed by processor(s) 81 to cause third-party system(s) 80 to perform operations. The operations can implement any one or multiple features described herein. The operations can implement example methods and techniques described herein. Example operations include the functionality described herein with respect to tools and other external resources called when training or performing inference with machine-learned model(s) 1, 4, 16, 20, 55, 65, etc. (e.g., third-party resource(s) 85).

FIG. 13 illustrates one example arrangement of computing systems that can be used to implement the present disclosure. Other computing system configurations can be used as well. For example, in some implementations, one or both of computing system 50 or server computing system(s) 60 can implement all or a portion of the operations of model development platform system 70. For example, computing system 50 or server computing system(s) 60 can implement developer tool(s) 75 (or extensions thereof) to develop, update/train, or refine machine-learned models 1, 4, 16, 20, 55, 65, etc. using one or more techniques described herein with respect to model alignment toolkit 17. In this manner, for instance, computing system 50 or server computing system(s) 60 can develop, update/train, or refine machine-learned models based on local datasets (e.g., for model personalization/customization, as permitted by user data preference selections).

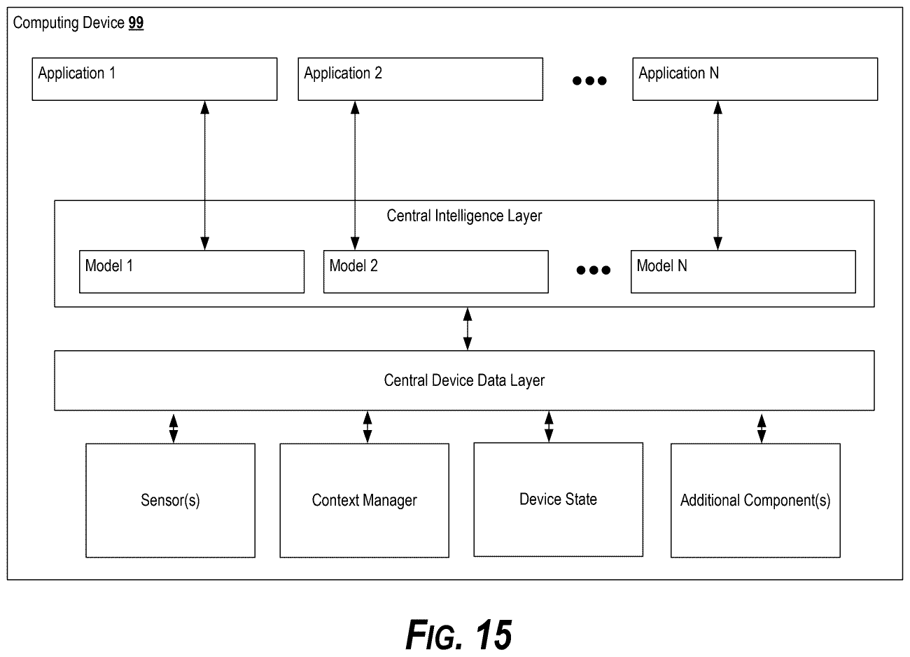

FIG. 14 is a block diagram of an example computing device 98 that performs according to example embodiments of the present disclosure. Computing device 98 can be a user computing device or a server computing device (e.g., computing device 50, server computing system(s) 60, etc.). Computing device 98 can implement model host 31. For instance, computing device 98 can include a number of applications (e.g., applications 1 through N). Each application can contain its own machine learning library and machine-learned model(s). For example, each application can include a machine-learned model. Example applications include a text messaging application, an email application, a dictation application, a virtual keyboard application, a browser application, etc. As illustrated in FIG. 14, each application can communicate with a number of other components of the computing device, such as, for example, one or more sensors, a context manager, a device state component, or additional components. In some implementations, each application can communicate with each device component using an API (e.g., a public API). In some implementations, the API used by each application is specific to that application.

FIG. 15 is a block diagram of an example computing device 99 that performs according to example embodiments of the present disclosure. Computing device 99 can be the same as or different from computing device 98. Computing device 99 can be a user computing device or a server computing device (e.g., computing device 50, server computing system(s) 60, etc.). Computing device 98 can implement model host 31. For instance, computing device 99 can include a number of applications (e.g., applications 1 through N). Each application can be in communication with a central intelligence layer. Example applications include a text messaging application, an email application, a dictation application, a virtual keyboard application, a browser application, etc. In some implementations, each application can communicate with the central intelligence layer (and model(s) stored therein) using an API (e.g., a common API across all applications).

The central intelligence layer can include a number of machine-learned models. For example, as illustrated in FIG. 15, a respective machine-learned model can be provided for each application and managed by the central intelligence layer. In other implementations, two or more applications can share a single machine-learned model. For example, in some implementations, the central intelligence layer can provide a single model for all of the applications. In some implementations, the central intelligence layer is included within or otherwise implemented by an operating system of computing device 99.

The central intelligence layer can communicate with a central device data layer. The central device data layer can be a centralized repository of data for computing device 99. As illustrated in FIG. 15, the central device data layer can communicate with a number of other components of the computing device, such as, for example, one or more sensors, a context manager, a device state component, or additional components. In some implementations, the central device data layer can communicate with each device component using an API (e.g., a private API).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein can be implemented using a single device or component or multiple devices or components working in combination. Databases and applications can be implemented on a single system or distributed across multiple systems. Distributed components can operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations or additions to the present subject matter as would be readily apparent to one of ordinary skill in the art. For instance, features illustrated or described as part of one embodiment can be used with another embodiment to yield a still further embodiment. Thus, it is intended that the present disclosure cover such alterations, variations, and equivalents.

Aspects of the disclosure have been described in terms of illustrative embodiments thereof. Any and all features in the following claims can be combined or rearranged in any way possible, including combinations of claims not explicitly enumerated in combination together, as the example claim dependencies listed herein should not be read as limiting the scope of possible combinations of features disclosed herein. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Clauses and other sequences of items joined by a particular conjunction such as “or,” for example, can refer to “and/or,” “at least one of”, “any combination of” example elements listed therein, etc. Terms such as “based on” should be understood as “based at least in part on.”

The term “can” should be understood as referring to a possibility of a feature in various implementations and not as prescribing an ability that is necessarily present in every implementation. For example, the phrase “X can perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

The term “may” should be understood as referring to a possibility of a feature in various implementations and not as prescribing an ability that is necessarily present in every implementation. For example, the phrase “X may perform Y” should be understood as indicating that, in various implementations, X has the potential to be configured to perform Y, and not as indicating that in every instance X must always be able to perform Y. It should be understood that, in various implementations, X might be unable to perform Y and remain within the scope of the present disclosure.

What is claimed is:

1. A computing system configured to generate predictions from electrocardiograms, the computing system comprising:
one or more processors; and
one or more non-transitory computer-readable media that collectively store:
a machine-learned encoder model configured to process an input electrocardiogram to generate, as an output of the machine-learned encoder model, at least a portion of a latent representation of the input electrocardiogram,
wherein the latent representation of the input electrocardiogram comprises a plurality of representation dimensions,
wherein a plurality of different subsets of the plurality of representation dimensions encode information from the input electrocardiogram associated with a plurality of different sub-bands of frequencies; and
a machine-learned prediction model configured to process at least the portion of the latent representation to generate, as an output of the machine-learned prediction model, a prediction;
instructions that, when executed by the one or more processors, cause the computing system to perform operations, the operations comprising:
obtaining the input electrocardiogram;
processing the input electrocardiogram with the machine-learned encoder model to generate at least the portion of the latent representation of the input electrocardiogram;
processing at least the portion of the latent representation with the machine-learned prediction model to generate the prediction; and
providing the prediction as an output.

2. The computing system of claim 1, wherein the latent representation comprises a nested latent representation and wherein at least a first sub-band of frequencies overlaps with at least a second sub-band of frequencies.

3. The computing system of claim 2, wherein the second sub-band of frequencies includes additional frequencies not included in the first sub-band of frequencies.

4. The computing system of claim 1, wherein the sub-bands of frequencies do not overlap.

5. The computing system of claim 1, wherein the latent representation comprises a nested latent representation and wherein at least a first subset of representation dimensions is a subset of a second subset of representation dimensions.

6. The computing system of claim 1, wherein different subsets of representation dimensions are separate from each other.

7. The computing system of claim 1, wherein the input electrocardiogram is expressed in a time-domain.

8. The computing system of claim 1, wherein the input electrocardiogram comprises a plurality of channels respectively associated with a plurality of electrocardiographic leads; and wherein the machine-learned encoder model is configured to individually process the plurality of channels.

9. The computing system of claim 1, wherein the prediction comprises a disease prediction or a diagnostic prediction.

10. The computing system of claim 1, wherein the computing system consists of a wearable computing device and wherein the machine-learned encoder model and the machine-learned prediction model are executed on-device on the wearable computing device.

11. A computer-implemented method to perform representation learning on electrocardiograms, the method comprising:
obtaining, by a computing system comprising one or more computing devices, an input electrocardiogram;
processing, by the computing system, the input electrocardiogram with a machine-learned encoder model and a machine-learned projection model to generate a latent embedding of the input electrocardiogram;
wherein the latent embedding of the input electrocardiogram comprises a plurality of embedding dimensions, and
wherein different subsets of the plurality of embedding dimensions encode information from the input electrocardiogram associated with different sub-bands of frequencies;
respectively processing, by the computing system, each subset of the plurality of embedding dimensions with a machine-learned decoder model to generate respective reconstructions of the input electrocardiogram;
evaluating, by the computing system, a loss function that comprises a frequency-domain reconstruction loss term that respectively compares masked frequency-domain versions of the input electrocardiogram to frequency-domain versions of the respective reconstructions of the input electrocardiogram, wherein each masked frequency-domain version of the input electrocardiogram has been masked to include only information contained in the corresponding frequency sub-band; and
modifying, by the computing system, one or more values of one or more parameters of at least the encoder model based on the loss function.

12. The computer-implemented method of claim 11, further comprising:
generating, by the computing system, a masked version of the input electrocardiogram;
wherein processing, by the computing system, the input electrocardiogram with the machine-learned encoder model and the machine-learned projection model comprises processing, by the computing system, the masked version of the input electrocardiogram with the machine-learned encoder model and the machine-learned projection model.

13. The computing system of claim 12, further comprising:
processing the original unmasked version of the input electrocardiogram with the machine-learned encoder model and the machine-learned projection model to generate a second, different latent representation of the input electrocardiogram;
evaluating an additional loss term that measures a similarity between the latent representation generated by processing the masked version of the input electrocardiogram and the second, different latent representation generated by processing the original unmasked version of the input electrocardiogram; and
modifying, by the computing system, one or more values of one or more parameters of at least the encoder model based on the additional loss term.

14. The computing system of claim 13, wherein the additional loss term comprises a variance-invariance-covariance regularization loss term.

15. The computer-implemented method of claim 11, wherein evaluating, by the computing system, the loss function comprises generating, by the computing system the masked frequency-domain version of the input electrocardiogram for each frequency sub-band, wherein generating, by the computing system the masked frequency-domain version of the input electrocardiogram for each frequency sub-band comprises:
performing, by the computing system, a forward Fourier transform on the input electrocardiogram to generate a ground truth frequency-domain representation of the input electrocardiogram; and
for each frequency sub-band: applying, by the computing system, a sub-band-specific mask to the ground truth frequency-domain representation of the input electrocardiogram to generate the masked frequency-domain version of the input electrocardiogram for the frequency sub-band;
wherein the sub-band-specific mask for each frequency sub-band masks data for frequencies that are not included in the frequency sub-band.

16. The computer-implemented method of claim 11, wherein the loss function further comprises a time-domain reconstruction loss term that respectively compares time-domain inversions of the masked frequency-domain versions of the input electrocardiogram to time-domain inversions of the frequency-domain versions of the respective reconstructions of the input electrocardiogram.

17. The computer-implemented method of claim 11, wherein the latent representation comprises a nested latent representation and wherein at least a first sub-band of frequencies overlaps with at least a second sub-band of frequencies.

18. The computer-implemented method of claim 11, wherein the latent representation comprises a nested latent representation and wherein at least a first subset of representation dimensions is a subset of a second subset of representation dimensions.

19. A computer-implemented method to perform representation learning on electrocardiograms, the method comprising:
obtaining, by a computing system comprising one or more computing devices, an input electrocardiogram;
processing, by the computing system, the input electrocardiogram with a machine-learned encoder model and a machine-learned projection model to generate a mask-free latent representation of the input electrocardiogram;
generating, by the computing system, a masked version of the input electrocardiogram;
processing, by the computing system, the masked version of the input electrocardiogram with the machine-learned encoder model and the machine-learned projection model to generate a mask-present latent representation of the masked version of the input electrocardiogram;
evaluating a loss term that measures a similarity between the mask-free latent representation and the mask-present latent representation; and
modifying, by the computing system, one or more values of one or more parameters of at least the encoder model based on the loss term.

20. The computer-implemented method of claim 19, wherein the loss term comprises a variance-invariance-covariance regularization loss term.
